(19) United States
(12) Patent Application Publication
(10) Pub. No.: US 2002/0019827 A1
(43) Pub. Date: Feb. 14, 2002

(54) Method and apparatus for managing documents in a centralized document repository system

(76) Inventors: Leon G. Shiman, Brookline, MA (US); Michael J. Andrews, Waltham, MA (US)

Correspondence Address: KUDIRKA & JOBSE, LLP, ONE STATE STREET, SUITE 1510, BOSTON, MA, 02109, US

(21) Appl. No.: 09/874,704

(22) Filed: Jun. 5, 2001

Related U.S. Application Data
(60) Provisional application No. 60/209,232, filed on Jun. 5, 2000.

(51) Int. Cl. G06F 17/30; G06F 17/60; G06F 17/21

(52) U.S. Cl. 707/200; 707/511; 707/512; 707/9; 705/51; 707/203; 707/522

(57) ABSTRACT

Users in a centralized document repository system must obtain valid copies of documents from a central server rather than obtaining the documents from another user. Since a valid document must be obtained from the server, the server can control access to the document, in particular by assigning a name to each copy of the document. The name is independent of the content and location of the document, but serves to authenticate the document and its lineage. In one embodiment, users must log onto the server and are assigned user specific authcodes that are used in a document name to identify a user who created or modified a document. In another embodiment, the server controls version numbers that are part of a document name and serve to indicate the version or copy of the document. In still other embodiments, users may enter information that becomes part of a document name.

### RELATED APPLICATIONS

This application is related to, and claims priority under 35 U.S.C.§119(e) of, U.S. provisional application Ser. No. 60/209,232, filed on Jun. 5, 2000 by Leon G. Shiman and Michael J. Andrews.

### FIELD OF THE INVENTION

This invention relates to document management systems and to systems for managing various document versions.

### BACKGROUND OF THE INVENTION

The following discussion uses, in part, terminology from relational database operations and client/server interactions designed to manage the storage and communication of data bits within a computer memory, that is, data bits organized according to standard protocols to represent alphanumeric text, images, or other information. Such descriptions are used by those skilled in the data processing and communication arts to convey the substance of their work to others skilled in the art. For a complete understanding of the present invention, a brief discussion of terminology and definitions appears below. Though terms are initially defined out of context, they are useful for an understanding of the description of the present invention.

The client/server model of interaction is a standard means for computer software programs to communicate over a network. In this model, servers are software programs or processes that wait for contact by a client process with instructions to perform a task for the client. Server programs take optimal advantage of multi-tasking and multi-user computer operating systems capable of multiplexing I/O from numerous simultaneous users and other server processes and from timesharing computer system resources, including the central processing unit, disk drives, memory, display, and other I/O resources.

FIG. 1 shows a sequence of client requests and server responses, representative of client/server interactions on the World Wide Web (WWW, or web). On the web, Hypertext Transfer Protocol (HTTP) is employed in communications between client-side web browser software and server-side web server software. Web browser software is used to read pages on the WWW that are indexed by names called Uniform Resource Locators (URLs). Although URLs may point to any type of formatted content, the web is characterized by content formatted in the Hypertext Markup Language (HTML), a form of tagged markup language.

Much of the power of the WWW is derived from an interactive HTML tag called a hyperlink, often rendered by web browser software in such a manner as to be easily selectable with a pointing device. Always attached to a block of content in a page, hyperlinks allow users to select other URLs for their web browser client.

The World Wide Web exists within the structure of the Internet. Thus, HTTP, the web protocol, is typically tunneled in the Internet Protocol (IP), the communication protocol underlying all communications on the Internet. The interactions shown in FIG. 1 are typical of those used by one embodiment of the present invention in which users interact with a remote server with their web browser software. The remote server generates HTML-formatted web interface pages 102 and 104 in response to client requests 101, 103, and 105. Parameters that the client sends along with each page request govern, in part, the content of each page. Generally, parameters are user-supplied answers to questions asked on the prior interface page, or selections made by clicking various buttons and interface widgets on the prior page; parameters may also include a state parameter “cookie” stored in the client side web browser.

A relational database is a collection of information stored in tables called “relations”, consisting of “rows”, called “tuples”, and columns called “attributes.” The value of each attribute of a tuple may take on any value from a set of values; forming the union of all values for one attribute is the attribute's domain. Relations between tuples exist if the domains of one or more of their attributes intersect.

Attributes are characteristics of a database “object class.” An object class defines a type of object comprised of certain attributes. Classes are abstract, specifying a type of object that may be created. Objects are discrete manifestations of object classes. In general, objects are metaphors for tangible entities, such as people and documents; these objects are defined by the values of their attributes in their abstract object class. Persons have names, hair color, height and weight. A person's unique identity is the collection of these attribute values. Every object can be indexed by the value of its primary key attribute, a unique name for the object.

Database objects are modified with combinations of updates, inserts, and deletions. Objects can be inserted into the database by creating the appropriate tuples (rows) in the appropriate relations (tables) to properly define the attribute values for the object and its relation to existing objects. Existing objects may be updated by adjusting one or more of the attribute values in the object. Objects may also be deleted by removing all attribute values from the database.

Although relational terminology is used in the description, in general, the use of the term “database” herein refers to any system enabling the storage and retrieval of data.

### SUMMARY OF THE INVENTION

In accordance with the principles of the invention, users must obtain valid copies of the documents from a central server rather than obtaining the documents from another user. Since a valid document must be obtained from the server, the server can control access to the document, in particular by assigning a name to each copy of the document. The name is independent of the content and location of the document, but serves to authenticate the document and its lineage.

In one embodiment, users must log onto the server and are assigned user specific authcodes that are used in a document name to identify a user who created or modified a document.

In another embodiment, the server controls version numbers that are part of a document name and serve to indicate the version or copy of the document.

In still other embodiments, users may enter information that becomes part of a document name.

### BRIEF DESCRIPTION OF THE DRAWINGS

The above and further advantages of the invention may be better understood by referring to the following description in conjunction with the accompanying drawings in which:

FIG. 1 shows a prior art client/server system operating over the World Wide Web.

FIG. 2 is a schematic block diagram of the preferred embodiment of the present invention.

FIG. 3 is a block schematic diagram of a prior art client-side computer on which the invention can run.

FIG. 4 is a block schematic diagram showing the structure of a document file name constructed in accordance with one embodiment of the invention.

FIG. 5 is a block schematic diagram representing objects in a database and potential relations between the objects.

FIG. 6, when placed together with FIG. 7, forms a flowchart illustrating the steps in a typical interaction between client-side software operating in a user's web browser and remote server software.

FIG. 7, when placed together with FIG. 6, forms a flowchart illustrating the steps in a typical interaction between client-side software operating in a user's web browser and remote server software.

FIG. 8 is a screen shot of an interface screen that allows the creation of a new user account.

FIG. 9 is a flowchart illustrating the steps in the process of creating a new user account using the interface screen of FIG. 8.

FIG. 10 is a screen shot of an interface screen that allows a user to log onto the system.

FIG. 11 when placed together with FIG. 12, forms a flowchart illustrating the steps in the process of logging on to the system using the interface screen of FIG. 10.

FIG. 12, when placed together with FIG. 11, forms a flowchart illustrating the steps in the process of logging on to the system using the interface screen of FIG. 10.

FIG. 13 is a screen shot of a list context interface screen that enables selection and manipulation of a list of discussion groups.

FIG. 14 is a screen shot of a list context interface screen that enables the manipulation and viewing of document objects.

FIG. 15 is a screen shot of a list context interface screen that enables selection and manipulation of a list of user objects.

FIG. 16 is a screen shot of a list context interface screen that enables selection and manipulation of a list of keyword objects.

FIG. 17 is a screen shot of a list context interface screen that enables selection and manipulation of a list of e-mail objects.

FIG. 18 is a table illustrating the maximum size and acceptable characters in the fields shown in FIG. 28.

FIG. 19 is a screen shot of an interface screen that provides a detailed context view of a single document object.

FIG. 20 is a screen shot of an interface screen that provides a detailed context view of an e-mail message object.

FIG. 21 is a screen shot of an interface screen that allows a user to modify his user object.

FIG. 22 is a screen shot of a subscription management interface screen that enables a user to change the subscription status of any group.

FIG. 23 is a flowchart that illustrates the steps involved in a user subscribing to an existing group.

FIG. 24 is a flowchart that illustrates the steps involved in converting a file from an upload to a document object in a document repository.

FIG. 25 is a screen shot of an interface screen that allows a user to specify a file residing on his system for contribution to the document repository.

FIG. 26 is a screen shot of an interface screen that allows a user to confirm that a file received by the server is valid.

FIG. 27 is a flowchart illustrating the process followed by a server in making an initial guess of an identity tag based on the name of an uploaded file.

FIG. 28 is a screen shot of an interface screen that allows a user to change the identity tag and format tag of an uploaded file.

FIG. 29 is a flowchart illustrating the process followed for error checking and correcting identity and format tags provided by a user.

FIG. 30 is a screen shot of an interface screen that allows a user to select a parent of record for an uploaded file.

FIG. 31 is a screen shot of an interface screen that allows a user to select discussion groups and keywords to relate to a document object.

FIG. 32 is a screen shot of an interface screen that allows a user to edit a description and feature list for a document.

FIG. 33 is a screen shot of an interface screen that allows a user to review all information entered and generated for a document during the contribution process and to return to previous screens to allow editing of the information.

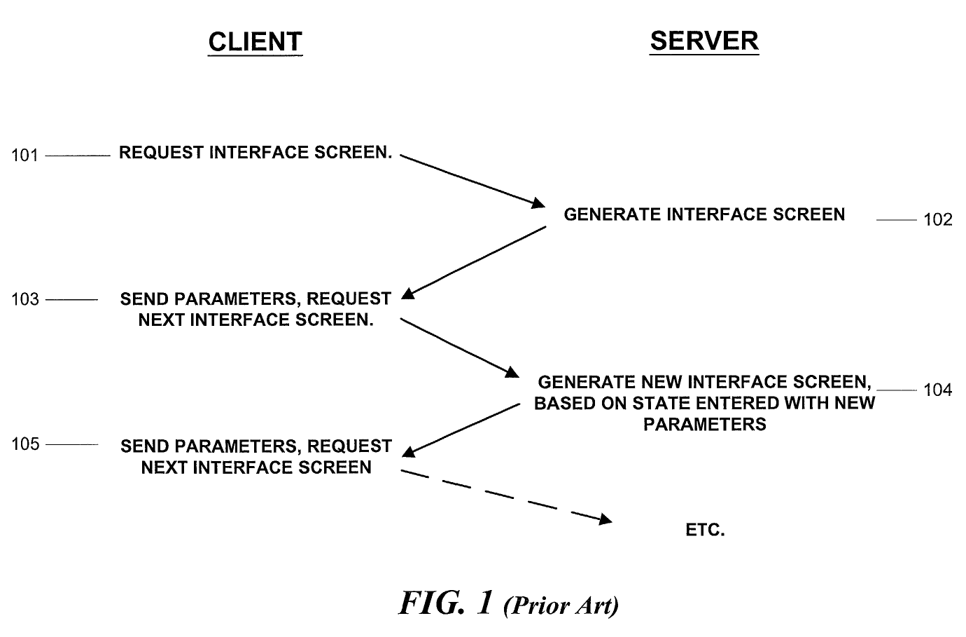

### DETAILED DESCRIPTION

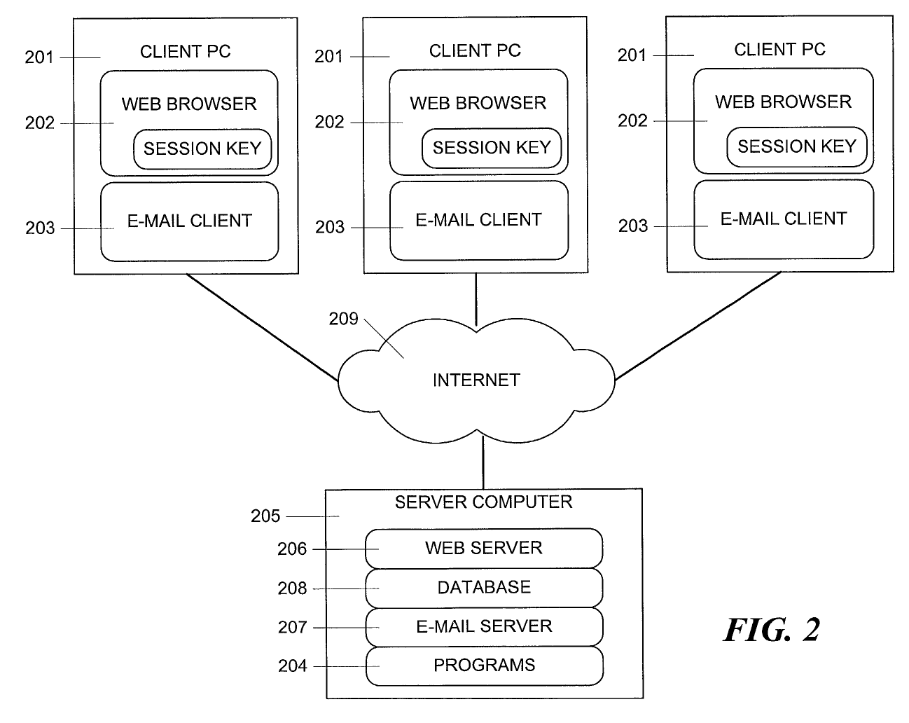

FIG. 2 is a block diagram of the preferred embodiment of the present invention. In this embodiment, users operating personal computers 201 with World Wide Web (WWW, or web) browser 202 and electronic mail (e-mail) 203 client software programs interact over the Internet 209 with a remote software program 204, running on a centralized server system 205. The centralized remote software program 204 handles input and output (I/O) to and from a web server program 206, an e-mail server program 207 and a general-purpose database 208. In accordance with the principles of the invention, the users must obtain valid copies of the documents from the server 205 rather than obtaining the documents from another user. Since, a valid document must be obtained from the server, the server can control access to the document, in particular by assigning a different name to each copy of the document. The name is independent of the content and location of the document, but serves to authenticate the document and its lineage.

Alternatively, in another embodiment (not shown), users can operate display terminals driven directly by a centralized server computer interact with a software program running on the server computer. The centralized software program handles I/O to and from the display terminals using the X11 display protocol. One skilled in the art would appreciate that this latter embodiment preserves the client/server method, although it may not even need conventional Internet services. The established client/server method is frequently used for server and client software programs that run concurrently on the same computer.

Users at personal computers 201 send documents to the server system 205, where each document is given a unique name and stored in the database 208. Other users with the required permission may then retrieve the document from the server system and send edited copies back to the server. Documents may be uploaded to the server system by the user, or downloaded by the user from the server system, using either the e-mail mechanism or the WWW mechanism, depending on the user's preference.

The unique name assigned to each document by the centralized server system incorporates author-assigned information, incremented version numbering, and a codeword owned solely by the author. Thus, users need only look at the name of a document to know its content, source, and age relative to other documents. These documents are said to be version-controlled because their identity can be related to a version number and because their modification history is known relative to other documents version-controlled by the same system.

Groups of users may hold discussions through private Internet electronic mailing lists managed by the remote server system. Users direct e-mail messages to specific Internet e-mail addresses on the server system that are managed by a one-to-many archiving reflector, which bounces e-mail messages it receives to the members of a discussion group. While electronic mail messages are distributed to the members of the group, they are also stored in the server system database. Subsequently, they may be accessed through the World Wide Web interface. Discussion participants may refer to documents by the document's unique name.

The unique names of documents stored in the server database comprise an identity tag and a format tag. Format tags describe the file format of the document, indicating the software program capable of understanding the structure of the document. Identity tags are assigned to each document to reflect its content, based on an interface-independent interview process completed by the document provider. The identity tag and format tag combine to produce a unique file name compatible with, and understood by, operating systems considered modern at the time of this writing.

Identity tags convey a short description of the document, a codeword representing the document's author, a compound version number incrementing with each new modification, and a status code. Using this system, a user may download a document from the server system to the user's computer, where it will retain the unique name. Thus, it may be easily identified later even without the remote centralized server system.

A document's unique identity tag promotes document ownership by including a code that identifies the document's author in the document's name. This mechanism proscribes the possibility of multiple authors working on a document of the same name. The user who publishes a document on the server system understands that she is the sole owner of the document.

One who is skilled in the art will appreciate that automatic merging procedures common to ancestral document versioning methods and systems are explicitly prevented in the described one-owner-per-document method. In the present invention, users collaborating to produce a single document maintain individual development threads. Users download documents from other threads, incorporating others' content into their development thread. While the scheme is flexible, it lends itself to the creation of a master document thread owned by a project manager. Rather than have a master document undergo many passive constant modifications, the project manager actively incorporates content from the separate threads of his developers. To the collaborators, the state of development of every thread is explicitly clear.

Documents may have parents and progeny. In the course of development, document owners derive content from other documents on the server system and may indicate these relationships. Relationships define a navigable history tree; it can reveal the development lineage of a single document as well as the interconnectedness of documents distributed throughout the system. Owners may define multiple parents for any document they own at the time of contribution to the server system, but they may not define progeny. If a document is truly new, its progeny cannot exist in the database prior to its incorporation. Causality in the history tree is not maintained if child can exist before parent. In the interest of preserving causality, progeny for new documents cannot be specified.

Thus, the centralized server system provides identity tag labels for documents that uniquely identify the document's content with respect to other documents stored on the same centralized server. Documents submitted to the server are stored indefinitely, along with a historical tree index to the content origins of each document. In addition, by incorporating an identifier of the document's author in the document's unique name, content ownership is fostered; individual users must guarantee the content of the documents that bear their names. Development paths can be retraced with the document history tree mechanism.

In a preferred embodiment, the present invention operates in a client/server environment, with different requirements for client-side computing and server-side computing. In general, the preferred electronic mail and web interfaces on the client computer system demand minimal system requirement. Due to the burden of managing the interactions of many simultaneous users, the demands on the server computer system may be higher. The server computer may also operate in a non-interactive mode, alleviating such requirements for user I/O hardware as a display, a mouse, or a keyboard, during normal operation.

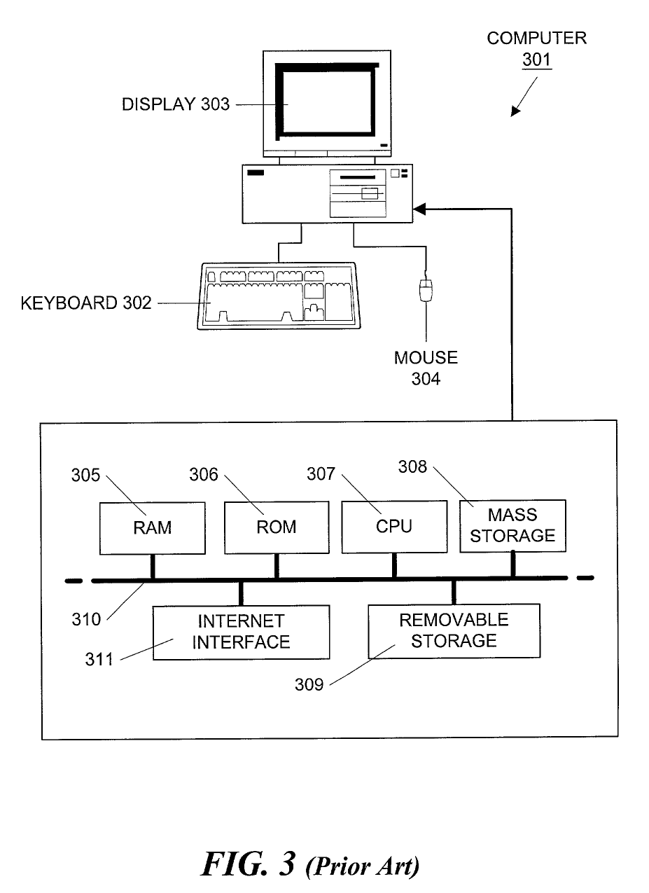

A typical example of a client-side computer is shown in FIG. 3. Computer 301 is a desktop computer, and may be of any type, including a PC-compatible computer, an Apple Macintosh computer, a UNIX-compatible computer, etc. Computer 301 usually includes a keyboard 302, display device 303 and pointing device 304. Display device 303 can be any of a number of different devices, including a cathode-ray tube (CRT), etc. Pointing device 304 as shown in FIG. 3 is a mouse, but the invention is not so limited. Computer 301 typically also comprises a random-access memory (RAM) 305, a read-only memory (ROM) 306, a central-processing unit (CPU) 307, a fixed storage device such as a hard disk drive 308, and a removable storage device such as a floppy disk drive 309, communicating over a system bus 310. The client computer, connected via the Internet, acts solely as an interface to the server computer and contains a mechanism for connecting to the Internet, such as a modem or local area network interface card 311. In a preferred embodiment, it must operate Internet electronic mail authoring software, as well as WWW browsing software supporting the HTTP 1.1 and transitional HTML 4.0 standards.

A server, in the conventional use of the term, is quite similar to the personal computer but supports multi-tasking, multi-user operation. Servers may be configured like computer 301, or may be of a more robust floor-standing design. Typically, a server computer is more powerful than a personal computer system, having faster and more reliable components, and larger mass storage 308. A server's Internet connection may support high bandwidth. In general, it must be capable of generating multiple web pages, receiving and transmitting multiple documents, and receiving and sending electronic mail, simultaneously. The server should also be configured to provide read-optimized access to the database.

The connection between client computer and server computer over the Internet may pass through many different physical network media such as point-to-point serial lines, broadcast Ethernet networks, frame-relay, etc. and may involve many devices such as hubs, switches, routers, etc. In general, the details of the Internet connection are hidden by the Internet Protocol (I P), used to access the Internet. So transparent is Internet connectivity that it is entirely possible for server and client programs to operate concurrently on the same computer system with no adjustments to the software program design.

The computer program to implement the present invention is typically written in a language such as Perl or C, although the present invention is not so limited. The database is typically of a relational type, supporting queries in the ANSI Structured Query Language (SQL), although the present invention is not so limited. These are the technologies currently employed by those skilled in the art to implement the system and method described herein.

The processes that comprise the present invention are defined with respect to operations on database objects. The structure of a database object is defined by one of the following classes: discussion group, electronic mail message, repository document, user, or keyword. In object-oriented programming, and in this discussion, an object is a unique instance of a data structure defined according to a template provided by its class. Each object has a set of values corresponding to attributes of its class. The set of values and the set of attribute in an object are not ordered. The data structure, together with its set of values, defines an object.

The use of the term “object” has other connotations in the art of object-oriented programming, not all of which apply to the use of the term in this discussion. Herein, it is useful to envisage an object as a structure together with additional properties. An object's structure is defined by its class. An object is said to “exist” and is, in some sense, tangible. Its class is a structure definition.

In the language of the art, an object is said to be instantiated when there exists an instance of its structure with an explicit set of values. In some cases, objects are uniquely characterized by a key. For example, one can instantiate a document object named “system-description”. One can refer to the document object “system-description”, or equivalently to the object “system-description” that is a document.

An object is said to be related to another object if a value of one or more of their shared attributes is the same. A relation can be a reciprocated, or bi-directional relationship. Relationships could also be unidirectional; a user object can be said to “own” a document object, while a document cannot be said to own a user. Such uni-directional relations can be called owner relationships.

Conventionally, a document is a digital data stream representing text and images that have structure and order. In the present invention, the concept of a document is not limited to text and images, but may be extended to encompass any form of digital data that can be discretized into a single digital data stream. The term “document” is used here for clarity.

Individual documents are entirely encapsulated within one structure, called a file, operations on which are managed by a computer operating system. Conventionally, files are stored on magnetic or optical media such as floppy disks, compact discs, read-only memories, and hard disk drives. All of these media contain digital data bits organized to form a hierarchical database of files called a file system. Files in a file system are identified by a unique name that is formed from a path name that represents the logical position of the file in the hierarchical file system and a file name that briefly describes the file, sometimes independently of the path name.

In the present invention, documents are assigned a unique file name that is constructed so that it will be preserved under any of the computer file systems considered modern at the time (e.g., Microsoft Windows FAT32, Linux ext2, UNIX File System (UFS), MacOS 8.x). File names constructed with the method of the present invention are formed with two components separated by a period: first, an identity tag with sixty-four or fewer characters chosen from the set of lowercase letters ‘a’ through ‘z’, integers ‘0’ through ‘9’, a dash ‘-’, and an underscore ‘_’ and second, a format tag with three or fewer alphanumeric characters. Documents having file names formed in this manner may be freely transferred from one computer to another and the file name will persist.

Separation of the filename into identity tag and format tag allows the content of the document, indexed by the identity tag, to be independent from the data format in which the document is stored. For instance, a Microsoft Word document may have the same identity tag (therefore, the same content) as a Portable Document Format document, differing only in their format tags (“doc” and “pdf”). It is the content of a document that is version-controlled, not the format in which it is stored.

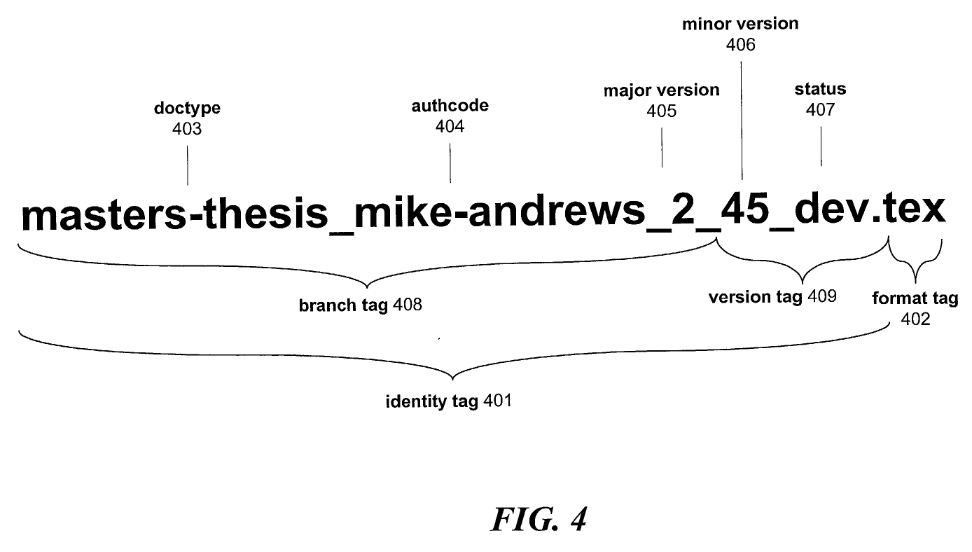

FIG. 4 shows the structure of a document file name, formed from an identity tag 401 and a format tag 402. The identity tag 401 is an underscore-delimited (_) composite alphanumeric string, created from five sub-tags: doctype 403, authcode 404, major version number 405, minor version number 406, and document status 407. Each sub-tag provides unique information about the identity tag, and all of the sub-tags are required to form a unique identity tag. The identity tag is further subdivided into a branch tag 408 and a version tag 409. The branch tag 408 comprises the doctype 403, authcode 404, and major version number 405. The version tag 409 is composed from the minor version number 406 and the status 407. Conceptually, the branch tag is sufficient to coarsely identify the content of a document. The version tag 409 accesses the individual documents under a particular branch tag.

A document object comprises a single identity tag, one or more format tags and several attributes that serve to describe the content of the document such that a document object represents a complete, single document that can be represented in one or more file formats. A document may be physically represented by many formatted data streams that are indexed by the corresponding format tags, but the described content (words and images) in each data stream remains the same. By providing multiple formats of a single document, users may choose the format best understood by their own computer systems with the assurance that content is the same as other formats of the same document. Typical format tags include Microsoft Word “doc”, Portable Document Format “pdf”, and Hypertext Markup Language “htm”.

Sub-tags in the identity tag have restrictions on content and formatting. The doctype is a user-defined, short description of the document. It may be no longer than eighteen characters containing lowercase letters, numbers and a dash (-). Otherwise, the user is free to assign to the doctype attribute any text meeting the requirements previously described, as long as the identity tag resulting from combining it with the other four attributes is unique.

The authcode is a code owned by the owner of the document, constructed from the same set of characters allowed in the doctype field. Authcodes uniquely identify a document owner; only the owner of any given authcode is permitted to use a given authcode in an identity tag. Authcodes permit some users to act as regents for named sources of information other than themselves. For instance, the president of a company may own two authcodes: one representing his name, the other representing the company name. In the preferred embodiment, by default, each user owns the authcode equal to his unique user name on the server system.

New branches of development on a document can be indicated with the major version number, which can take on integer values from 1 to 999. The minor version number, in conjunction with the branch tag, indexes a particular version of a document and may take on integer values from 1 to 999. While the major number can be changed at will by the document owner, the minor number is controlled by the server system according to two rules. First, in a new branch (that is, a branch having a new combination of doctype, authcode, and major number) the minor version must be 0. Second, each successive contribution to a branch adds exactly one (1) to the minor version number. During normal development of a document, the minor version number is incremented by one each time the owner submits a new document. If the owner creates a new branch, then the minor version of the first identity tag in the new branch is set to zero.

The last field in the identity tag is a status code intended to reflect the level of acceptance of the document. Unlike the prior sub-tags, it is a user-assigned, descriptive label comprising up to three lowercase letters. The status code alone does not identify new content for a document. In the case of two identity tags differing only in status code, the content is guaranteed by the server system to be identical.

The server file system stores documents while the server system database stores the aforementioned identity tag and format tag. The complete document object has additional descriptive attributes described below.

Document objects contain “metadata” that comprises information entered by the document owner and stored along with the document itself. This metadata includes a plain text description and a bulleted feature list, both provided by the document's owner upon submission into the server database. The description serves to further explain the content of the document in a manner much more detailed than the description provided by the filename. The bulleted feature list may reflect major features or changes from prior versions. By default, successive versions of a document inherit the description and features of the prior version; the contents of these attributes may then be altered by the owner to reflect the changes in the new version.

Further information is also included in the metadata. For example, the server system records modification times and the ancestry of documents. First, each document object contains a time-stamp set at the moment of receipt by the server system, or at the most recent change. Second, each document object may have relations to zero or more parent documents called the “parents of record”. In indicating parents of record, the document is said to have derived some portion of its content from its parents. The user may have formed the document by editing one of the parents of record, or he may have merely used an idea from a document. Document owners are free to choose parents of record from among the viewable documents in the server database. A system-wide ancestry tree, a form of genealogical reference of document development, is formed by the server system by analyzing the parents of record of every document.

Documents may have relations to discussion groups that the owner has joined. Such relations effectively limit the visibility of documents to members of the related discussion groups. Many group relations can be named, expanding access to the document to include all users in the related groups; a user need only be in one of the related discussion groups to view the document. If no groups are named, the document is publicly accessible by any user on the system. The group identifications are also part of the metadata.

Descriptive keywords chosen from a system-wide constrained list of keywords can be related with the document object. The keyword list is constrained, so that searches on keywords return meaningful results. Keywords are also part of the metadata.

Users who have access to the document may attach their names to a change notification list for documents in the branch tag. Users on the list will be notified through electronic mail when an update has occurred in a document in the chosen branch. Examples of changes include, but are not limited to, new minor versions, status code changes, and new formats made available.

Document objects can be deleted from the database. However, this action should be considered rare, and may only be performed by the system administrators. Documents are stored in an archive, meant to preserve their existence indefinitely; arguably, removing content from an archive destroys the purpose of the archive. When a document is deleted, the database must be searched for other documents that have indicated this one as a parent of record; those that are found lose the document as a parent of record, leaving holes in the history tree.

Inserts can be made to the document repository by the users; indeed, this is the purpose of the repository. A document may not be updated, save for status code changes and automatic format creation, as this action, too, destroys the purpose of a document archive. If changes are to be made, a new identity tag and corresponding document object must be created.

Descriptive keywords, intended to serve as controlled identifiers for discussion groups and repository documents may have a relations to any object in the database. For example, documents can be linked to descriptive keywords, so that searches are faster and search results are relevant; discussion groups are linked to topic keywords, so that users may have some idea of a group's areas of interest. A user may select specific keywords, so that searches and browsing operations might return results of particular interest to the user. Keywords, like documents and users, are objects that can be related to other objects. Keyword objects contain the name of the keyword and any references to related objects.

The server system maintains a list of acceptable keywords; its content may be regulated by the system administrators. For an object (document, group, or user) to be bound to a keyword, the keyword must be in the controlled list. New keywords may be requested by the user, for which the system operators will make a decision to approve or reject. However, a newly requested keyword is bound temporarily to the object; should the operators reject it, the keyword will be deleted from the database, and the requester will be notified through electronic mail of the keyword rejection. In one embodiment, keyword name length is limited to sixty-four lowercase letters, numbers or dashes.

Keyword objects can be deleted completely from the database. Keyword objects can be inserted into the database, pending approval by the database administrator. Keywords can also be updated by changing their relations to other objects. The name of a keyword object, however, may not be changed.

To provide forums for online collaborative discussion, the server manages subscription-based electronic mailing lists. Electronic mailing lists are represented in the server system by a discussion group object that contains relations to other objects in the system, as well as values that describe the topic of discussion in the group. In one embodiment, groups have a descriptive name less than thirty-two characters long, containing lowercase letters, numbers, and dashes. In the preferred embodiment, the name refers to the discussion group in both the web interface and the electronic mail interface.

A discussion group's relations with users take the form of owner or member. Members of a discussion group are users who have chosen to participate in the discussion group and are represented by bi-directional relations between the discussion group object and each member user object. Owners are users (sometimes called the moderators) who approve or deny subscriptions to groups. They may choose to regulate the discussion by approving or denying individual e-mail messages directed at groups. The owner relationship is unidirectional: every discussion group is owned by exactly one user, but a user is not owned by a discussion group. Users may participate in more than one group, and may own more than one group.

The establishment of a group may help foster discussion on a particular topic, adhere to a particular charter, or simply to provide a “virtual” meeting place. For instance, a group may be created to permit the members of a small software team to discuss detailed issues related to their software development practices. Groups can be related to well-chosen keywords and documents to help define its purpose to users interested in joining the group. Group objects also contain one-line descriptions and extended format descriptions.

Discussion groups cannot be deleted from the database without breaking the relationships to the e-mail objects that form the conversations of the group. If a group is deleted, its related e-mail objects will lack the context that came with being part of the well-defined discussion group. Thus, the removal of a discussion group often necessitates removal of related e-mail objects.

Groups are inserted into the database by system administrators, when users request new groups. Groups are updated whenever an electronic mail is received on the accompanying mailing list. The system administrator and the group owner may update a group to change the description or insert and delete member users.

A discussion group's related keywords provide a summary description scheme useful for searching through the list of discussion groups on a system. A discussion group's related documents are documents of interest to members of the discussion group. Frequently, the documents are produced collectively by the members of the discussion group. Discussion groups have two descriptive attributes: a one-line description, and an extended text description. The attribute values are useful for different user interface views in the preferred embodiment. Typically, one-line summary descriptions accompany a tabular list of many discussion groups, while the extended description is used for interface screens that show a single discussion group and the values of its attributes. Individual electronic mail messages in these discussion lists are stored in the database using electronic mail objects with relations to the discussion group objects defining the groups in which the discussion took place. Electronic mail messages may be communicated to many discussion groups.

The server preserves e-mails sent to members of a discussion group. E-mails are stored as database objects. Like other system objects, e-mail objects may be related to any other system objects. E-mail objects, however, are defined primarily by their content: a standard Internet message header and body structure and multipurpose Internet mail extension (MIME) format attachments. Unlike document objects that undergo a process of naming and describing by the user before being entered into the system database, the server system exercises control over the client-side creation of e-mail messages. Thus, many of these relations cannot be explicitly defined; instead, they must be derived or inferred from the content of the e-mail.

Internet RFC 822, “Standard for the Format of ARPA Internet Text Messages,” defines the basic structure of the header and body of an Internet e-mail message. From this structure, the server interprets directly a number of relations and parameters: the sender's Internet e-mail address, the discussion groups to which the message was sent, the subject of the message, and the time the message was sent. Indirectly, the server system may search for keywords and document names present in the body of the e-mail message. If any are found, the names are inserted into the electronic mail object, relating it to the named objects.

E-mail objects are communicated under the rubric of one or more discussion groups. The relationship between groups and e-mails is symbiotic in that, without e-mails, groups are little more than well-defined communication channels with no communication; without groups, e-mails lack the context and categorization necessary for usefulness. Discussion groups provide the means for users to participate in directed discourse according to a charter and subject of interest. E-mail objects are typically indexed to a specified discussion group. For security, a user may only retrieve e-mail objects related to discussion groups of which he is a member.

E-mail objects can be deleted completely from the database. However, this action should be considered rare, and may only be performed by the system administrators. E-mails are stored in an archive, meant to preserve their existence indefinitely; arguably, removing content from an archive destroys the purpose of the archive. Users can insert e-mail objects to the database; indeed, this is the purpose of the archive. E-mails may not be updated, as this action, too, destroys the purpose of a discussion archive.

Every user of the server system has a user object representation in the database. User objects serve to identify a particular human user to the system via a user name, password, and session key. In the preferred embodiment, the current state of user interaction with the server system is preserved in the user object, represented as a hash table of key and value pairs. As with the other objects, users may be related in a number of ways to any object in the system.

A user has a unique name, called a user name, and a password that he uses to log on to the system. Once logged on, the user's browser receives a unique session key called a “cookie” from the server system, which it then stores on the user's computer. In further interactions with the server system during the current session, the user is identified by this session key and is not required to enter the user name and password combination again.

A user is related to discussion groups he owns and discussion groups of which he is a member. A user is related to document objects in two contexts: he may own certain documents, and he may be on the change notification list of certain documents. The relation between a document and an owner is defined by the authcode used in the document's identity tag. Additionally, a user may have a relation to a document through the document's notification list. If the user is on the notification list, he is contacted via electronic mail when certain document branches are updated. The notification relationship is unidirectional, as the user is notified when the document changes, but the document is not notified if a user changes.

The user may have indicated an interest in a number of keywords, forming a relation between the keyword names and the user's name. Embodiments of the invention employ user-related keywords to order lists of database objects with a preference towards those objects related to the same keywords. For instance, a list of documents can be ordered such that a document related to a user's related keyword can be given a higher precedence in the list.

The user is related to electronic mail messages he has authored or in which he is mentioned. In the body of an electronic mail object, the author may have chosen to refer to one or more system users by name; these relationships are discovered and explicitly recorded in the database.

The current state of the user interface is preserved in the user object. In one embodiment, operation of the user interface is governed by many state parameters stored in the user objects by key/value pairs. One who is skilled in the art will appreciate that HTTP, as used in the present invention, does not preserve state; an implementation detail of client/server web applications, however, is the provision for some form of state preservation on the server system.

Users can be deleted completely from the database, a task performed by a system administrator. In removing users from the database, a decision must be made regarding the transfer of ownership of the user's authcode. To prevent other users from masquerading as the defunct user, the authcode may be retired indefinitely. Authcodes may be transferred to other users in the defunct user's organization, or they may be retained by a phantom user who inherits some characteristics of the defunct user.

Pending approval by the system administrator, user objects can be inserted into the database. Users are also frequently updated, in that the state parameters of any user object are under constant modification. The user name may not be changed.

An object is said to be related to another object if a value of one or more of their shared attributes is the same. A relation can be a reciprocated, or bi-directional relationship or uni-directional. In an example of a unidirectional relationship, a user object can be said to “own” a document object, while a document cannot be said to own a user. Such uni-directional relations can be called owner relationships. Relations can take on different meanings depending on the usage context. In general, the relations described below are bi-directional, although certain cases are uni-directional ownerships.

In a relational database, relations are represented by tables, consisting of rows called tuples, and columns called attributes. The value of each attribute of a tuple may take on any value from a set of values; forming the union of all values for one attribute is the attribute's domain. Relations between tuples exist if a value in a shared attribute is the same.

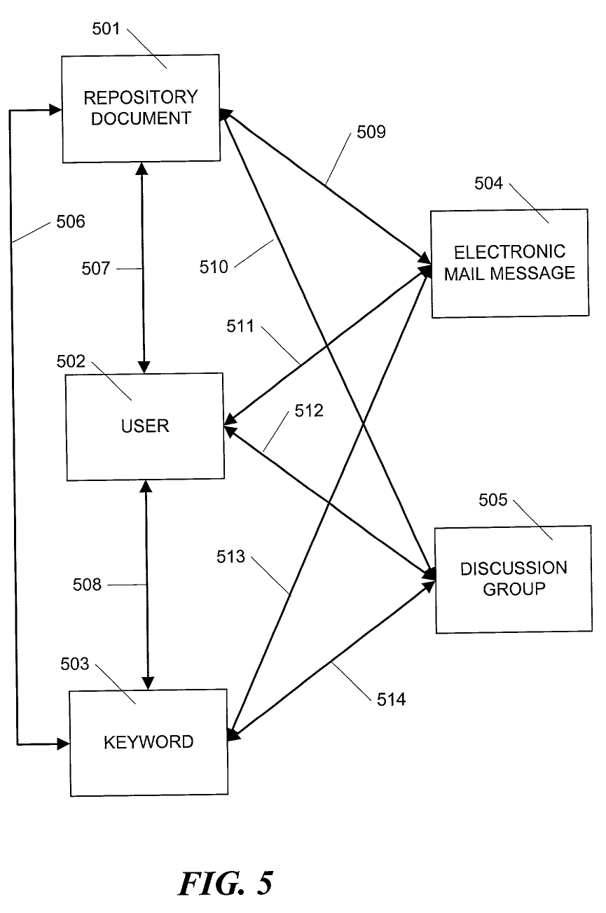

In FIG. 5, ten relations can be defined between the objects including document 501, user 502, keyword 503, e-mail 504 and group 505 in the database. These relations are represented by arrows 507-515 and include keywords that may be related to any number of documents, providing an index constrained to the content in the repository. The relations are described as follows:

As indicated by relation 507, users may own one or more documents. Each document has exactly one owner. Users may also elect to receive notification when content is updated in a document's branch.

As indicated by relation 508, users may indicate an interest in certain keywords. Other objects with relations to these keywords will take precedence in listings. Relation 509 illustrates that repository documents may be electronic mail attachments, inheriting their description from the body of the e-mail. In addition, e-mails may have relations to documents in the repository if these documents are part of the discussion.

Relation 510 shows that discussion groups may have relations with documents, both to provide context for the documents and to secure documents. Documents related to discussion groups are only visible to users who are members of those groups.

Relation 511 shows that a user may own any number of electronic mail messages if the user authored those messages. Each e-mail message is owned by exactly one user. In addition, an e-mail message may refer to any number of users in its body, indicating some relation of relevance. Relation 512 illustrates that a user may be the owner of any number of discussion groups, controlling access to them. Each group is owned by exactly one user. A user may also be a member of any number of discussion groups. Each group may have any number of members, including its owner. In order to view objects that are related to a particular group, a user must be a member of that group.

In accordance with relation 513, electronic mail messages may be related to any number of keywords, useful as an index to their content. Relation 514 illustrates that discussion groups may have relations to any number of keywords, signaling the content of discussions. Finally, relation 515 indicates that discussion groups may be related to any number of electronic mail messages. E-mails may be related to any number of groups.

The user interfaces that drive various processes within the system govern operation of the present invention. In a preferred embodiment, the user interfaces are web pages and electronic mail messages created and received by the server system. To some extent, the nature of these interfaces drives the underlying database manipulation processes. Regardless of the embodiment, users can store documents that are given unique names and can communicate among the collaborators.

In addition, in the preferred embodiment, users interact with a remote server computer system with a World Wide Web browser using client/server style interactions. For each user interaction with the server system, the user's client-side web browser first requests a new page from the server system. Second, the server system chooses what content to deliver to the client. Last, the web server transmits the content to the user's web browser.

On the World Wide Web, pages typically constitute an HTML-formatted data stream. However, pages can also be bit-mapped images, documents, digital audio, or data streams formatted in a manner unfamiliar to the web browser. In the latter case, the data stream may be stored on the user's mass storage disk device for later interpretation by computer software that understands the format. The Hypertext Transfer Protocol (HTTP) is used for communications between web browser and web server. It indicates the content of any data stream it is employed to transfer using format identifiers from the Internet standard Multipurpose Internet Mail Extension (MIME) type list defined in Internet RFC's 2045, 2046, 2047, 2048, and 2077. For instance, such MIME types as “text/plain”, “text/html”, “application/pdf” typify those types transmitted via HTTP. The Internet media type registry is currently accessible through a hierarchically organized index on the WWW at http://www.isi.edu/innotes/iana/assignments/media-types/.

Once a user has signed on to the system, his web browser retains a locally stored cookie that acts as a unique session identifier for the remote server. When the web browser requests a new page from any server, it searches the cookie file for cookies that are valid for the requested URL. All valid cookies that are found are piggybacked onto the browser's request to the server. When the web server receives the cookies, they may be employed to alter the content that is served to the client.

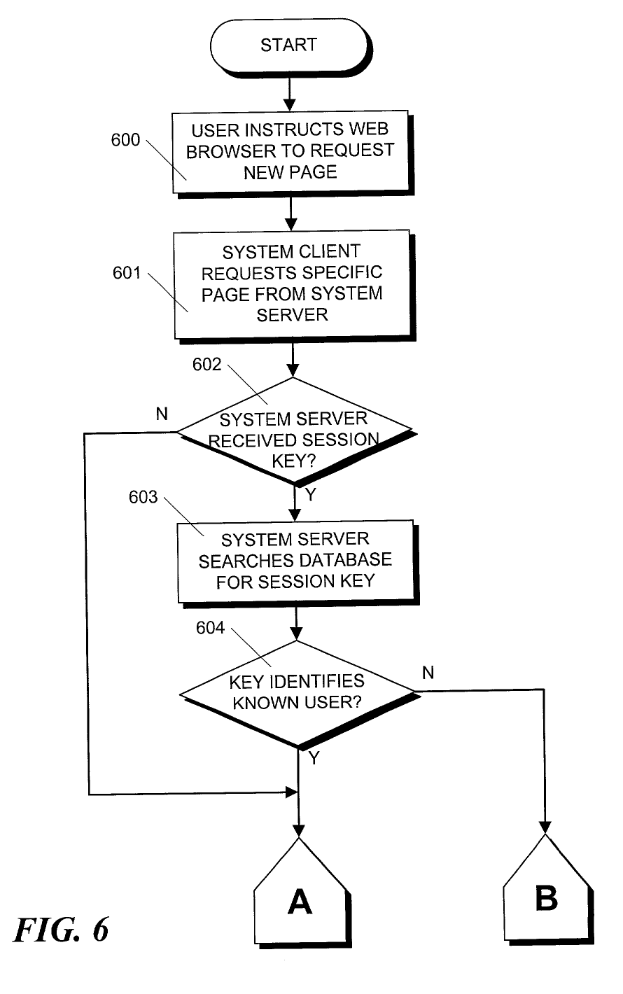

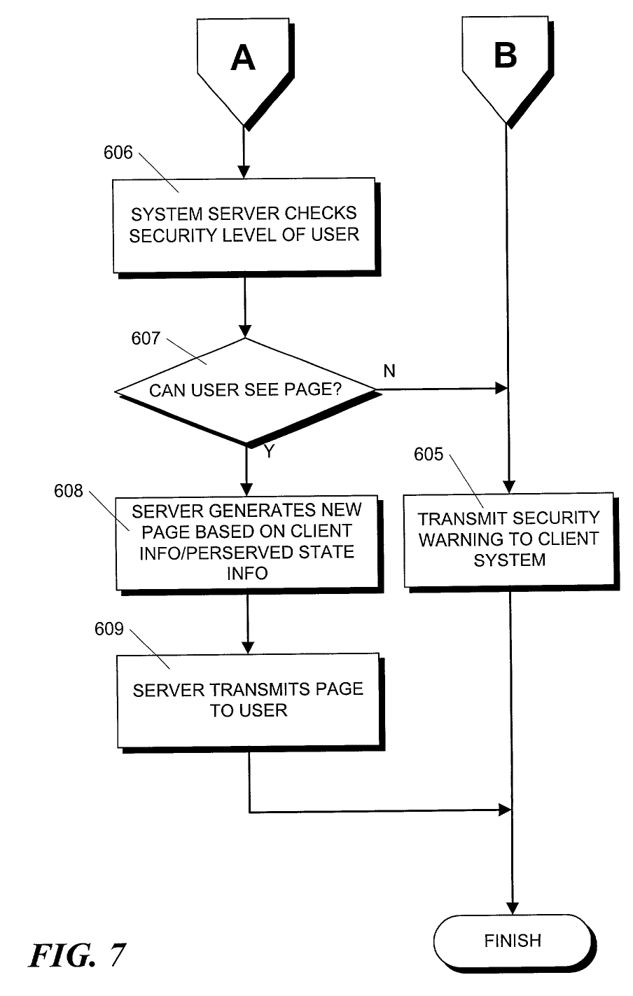

FIGS. 6 and 7 form a flowchart that describes the means of interaction between the client-side web browser and the computer software programs on the remote server over the World Wide Web. All web-style interactions involve a client request followed by a server fulfillment of the request. Thus, the process of FIGS. 6 and 7 is the flow of events between and including the request and its fulfillment.

Starting in step 600, the client instructs the web browser to request a new page. Next, in step 601, the client-side web browser sends a request to the remote web server. A specific URL on the web server is requested with the Hypertext Transfer Protocol; included in the request may be various parameters including a session key cookie stored by the web browser and valid for the requested URL. In step 602, the server processes the request to determine if a session key was sent. If no session key was sent, the user is declared anonymous and control proceeds to step 606; otherwise, control passes to step 603. In step 603, the user object database is searched for a session key matching the one transmitted. If no match was found in step 604, it is assumed that the user is trying to masquerade as another user, and an error is generated in step 605.

Step 606 is reached if the key matches a known user or the user is anonymous. Based on group memberships of the user (there are no group memberships if the user is anonymous), the server decides in step 607 if the user is allowed to view the requested information, transmitting an error in step 605, if not.

In step 608, the server system generates or loads the appropriate new page for the user, based on the user's identity, state parameters, transmitted parameters, and the requested page. The page is sent over the network to the user in step 609 and the process finishes.

The human-computer interface of the preferred embodiment is a collection of screens that allow users to view and manipulate database objects. In general, each class of database object has two types of interfaces: one allowing browsing of many objects simultaneously in a tabular summary view, and one allowing the manipulation of a single object in detail. In addition, various functions of the present invention are driven by ordered sequences of interface screens that guide the user through a complex process, typically affecting more than one database object.

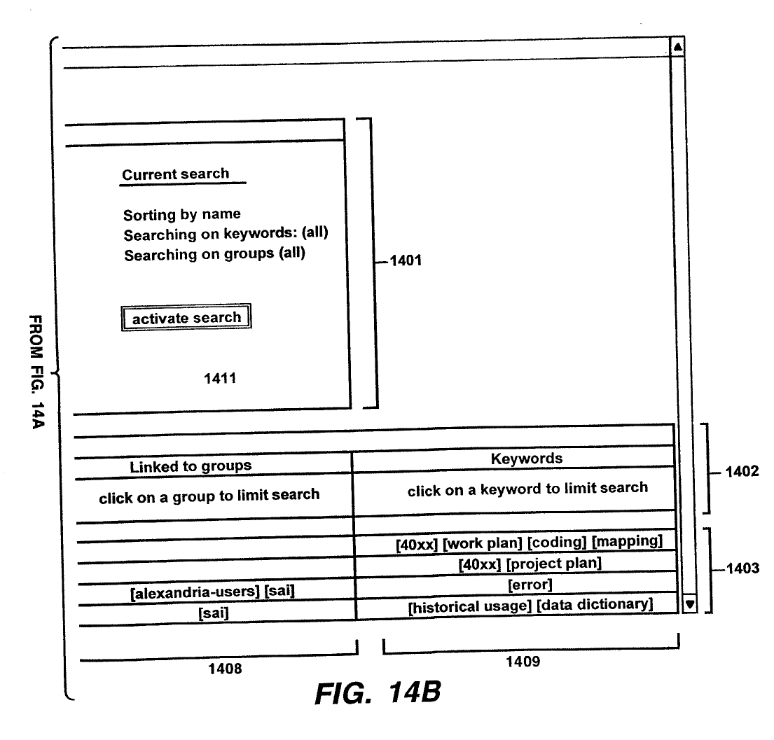

With the exception of the log-in and log-out functions, complex functionality driven by sequential screen access is invoked from one or more of the two object view interfaces (list or detailed). Overall, the system is operated with a hierarchy of state-preserving interfaces that are selected by elements resembling file folder tabs at the top of an interface (for example, these tabs are illustrated in FIG. 14, as elements 1412.) From the coarsest perspective, one selects from among three object classes: users, documents, and groups. Selecting or invoking a “tab” brings the selected object class into focus. The state of each class is preserved independently of the other object classes, each of which may be selected at will. When returning to a previously visited object class “tab”, the screen appears as it did the last time the object class was in focus.

Similar elements are used to enable the selection of a mode of interaction within a particular object class (for example, these elements are illustrated as mode selection tabs 1413 in FIG. 14.) The mode selection tabs are changed either by the interface to inform the user that the interface has changed, or by the user to force a change in the interface. Interface modes are distinct to each object class. In general, modes enable viewing lists of objects in the class, or one object in detail.

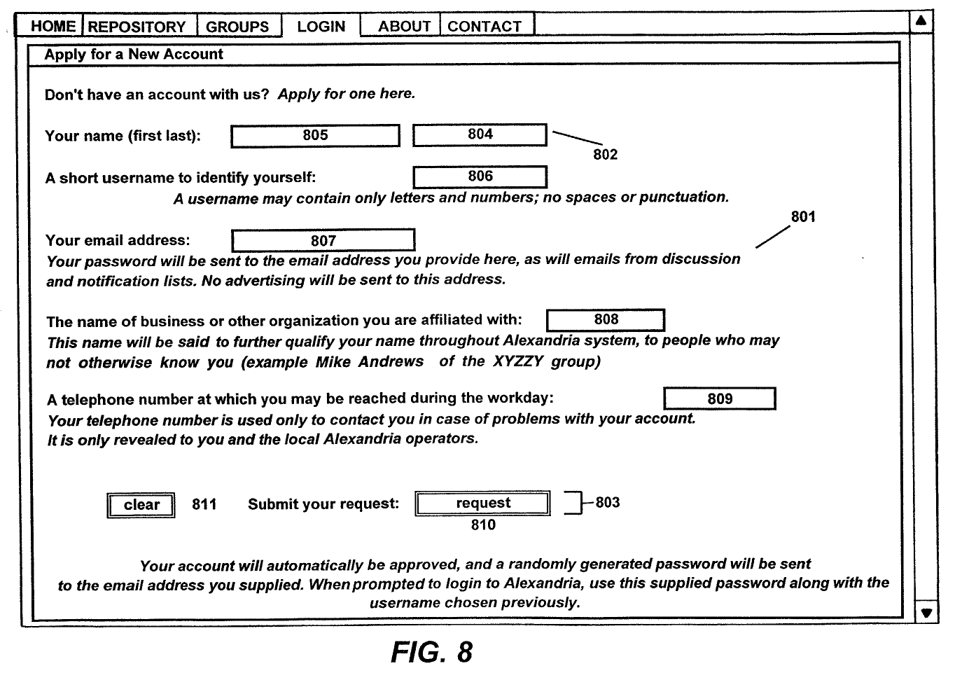

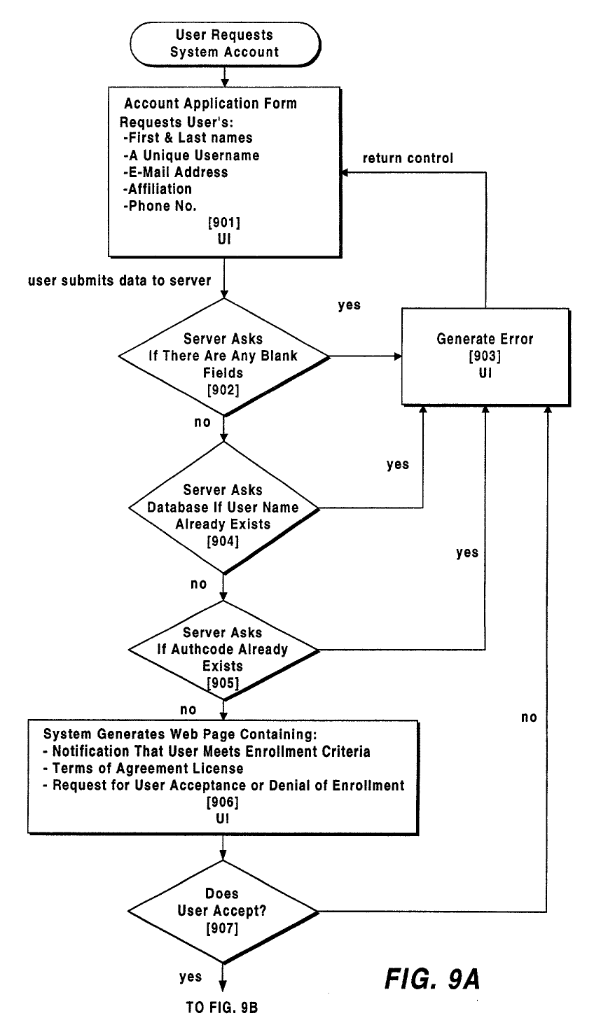

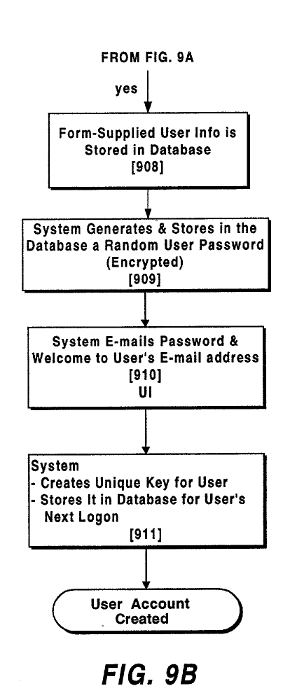

FIG. 8 and FIG. 9 describe a process that grants access for first-time users by creating a new user object. With a user object, users may access or contribute secured documents and electronic mail messages. The system asks the anonymous user to begin this process from a number of contexts in the interface. First, an ever-present “login” functionality directs unregistered users to begin the registration process. Second, the option to sign up for an account is presented at the time of denial of access due to security restrictions.

FIG. 8 is an interface screen containing descriptive text 801, form fields to be filled out 802, and control buttons 803 that appears when a “login” tab is selected. Depending on the exact implementation of the client-side software, information may be entered into this form in a variety of ways, including myriad means designed for the disabled. For forms of this type, and for all subsequent interfaces, the typical means of interaction is with a standard keyboard (e.g., a PC-style 101-key) augmented with a pointing device (e.g., a mouse). The pointing device is used to select the on-screen buttons, invoking the action of the on-screen buttons with physical buttons mounted to the pointing device. For right-handed mouse users, the left button is depressed and released; this action is, by convention, called “left-clicking”. Additionally, the pointing device may be used to bring individual form fields into focus through the same left-click operation; information may subsequently be entered into the in-focus field with the keyboard.

The displayed form requests the following information: last name 804, first name 805, a requested short user name 806, user's Internet e-mail address 807, the name of a business or organization the user is affiliated with 808, and a business telephone number at which the user can be reached in the daytime 809. The clear button 811 resets the state of the form. By depressing the request button 810, the states of the form fields are conveyed to the server program.

FIG. 9 describes the process flow of the user-driven account creation process. In step 901, an account application form is presented to the user (in a preferred embodiment by a drawing a Web page) as shown above in FIG. 8. Once the server program receives the completed form, it begins a validation check on the information submitted. In step 902, the server system checks for fields that have been left blank. If any blank fields were detected, it generates an error 903 and re-displays the form 901, highlighting the blank field(s). When all fields have been filled out, step 904 checks that the user name requested doesn't already exist in the database. If no user has the user name, control passes to step 905; otherwise, an error is generated in step 903, re-drawing the form 901. In step 905, the server queries the database for existing authcodes matching the requested user name—the new user must have control over the use of his user name as an authcode. If the requested user name is not in use as an authcode, control passes to step 906; otherwise, an error is generated in step 903 and control passes to step 901, re-displaying the form.

In step 906, a form is shown informing the user that his application has been accepted. It presents the “Terms of Agreement license” and requires the user to accept or to decline the new user account. If the user accepts, control is passed to step 907. If the user refuses to accept the terms, a detailed error is generated in step 903, informing the user that little use can be made of the present invention without an identifying user account; control then returns to step 901.

Once the user has accepted the license, steps 908 through 911 complete the user object initialization process. In step 908, the information supplied in the form of 901 is stored in the database, forming a relation with the requested user name from 901. In step 909, a random password is generated and stored encrypted in the database. In step 910, the password of 909 is e-mailed to the user's indicated Internet e-mail address. This is a security measure, verifying the purported identities of new users. To log on to the system, the user needs to receive the password, and in order to receive the password, the user needs to have supplied the system with a correct e-mail address in 901. The process is completed in step 911: a unique session key is created for the user and stored in the database for use once the user signs on.

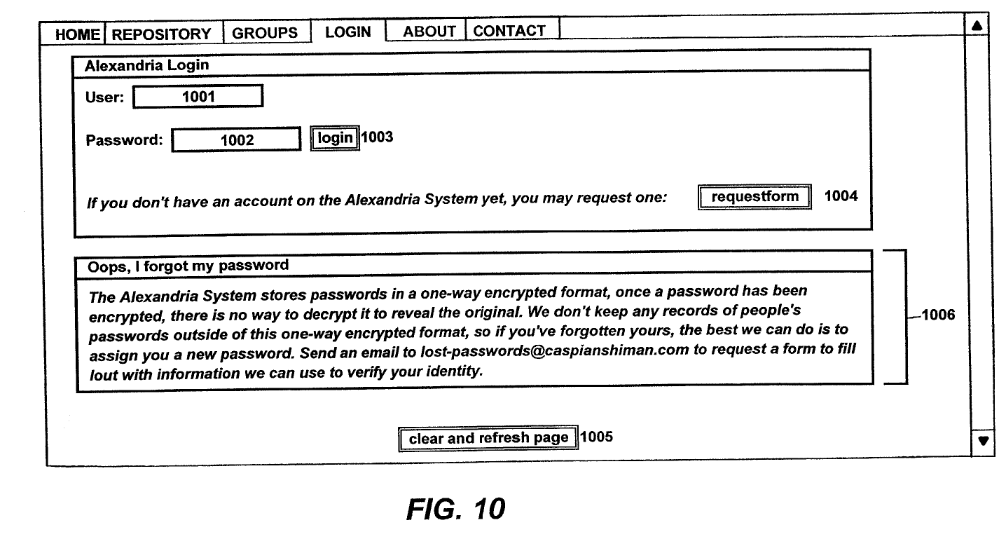

FIG. 10 is an interface screen, defining input to the user sign-on process. It contains fields for the user name 1001 and the password 1002, as well as buttons to invoke the log in process 1003, request a new user form 1004, and clear the form 1005. The clear button 1005 resets the state of the form. The request-account button 1004 invokes the process described previously in FIGS. 8 and 9. Accompanying the input components is a note 1006 describing a process for obtaining lost passwords.

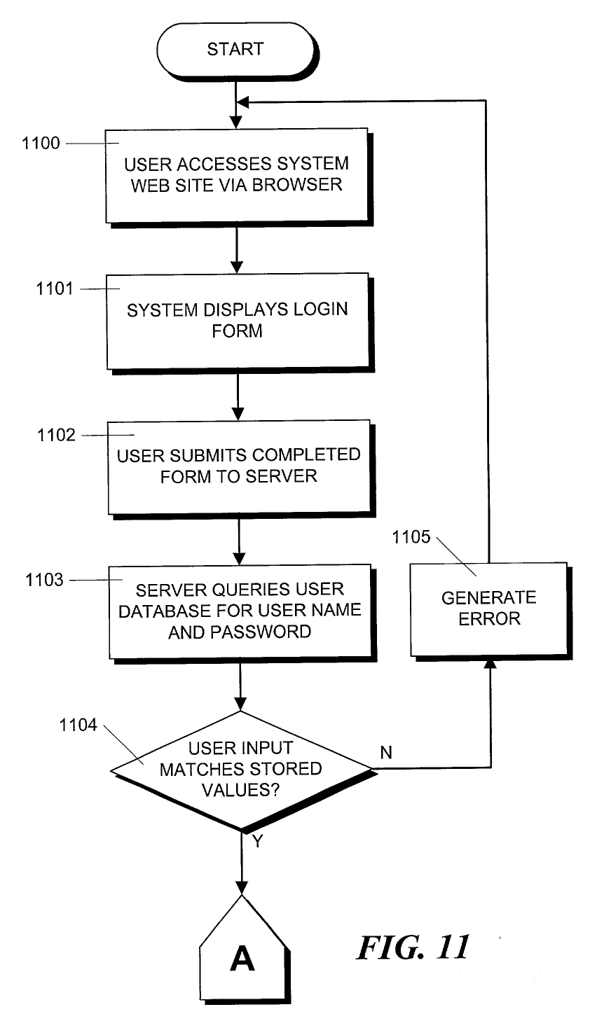

FIG. 11 is a flow diagram of a routine that signs the user on to the system. In any embodiment, the user supplies his user name and password and the system identifies the user as being “logged on.” In the preferred embodiment, a unique session key is transferred to their web browser, which stores the session key as a “cookie” on the user's computer. This session key is then transferred by the web browser client to the web server system during every web page request, thus the server system can use this session key to identify the user context for drawing the particular requested web page.

The interface shown in FIG. 10 is invoked in FIG. 11, which begins in step 1100 where the user accesses the web site via the browser. In step 1101 the system displays the login form requesting the necessary login information as shown in FIG. 10. Step 1102 is invoked when the user activates the log-in button 1003, passing the form data to the server system. In step 1103, the server system queries the user database for the supplied user name and password. In 1104, if a match is found, control proceeds to step 1106, otherwise an error is generated 1105 and control returns to step 1101. In step 1106, the system retrieves this user's session key from the database; in 1107, the key is transmitted to the client-side web browser, which stores it as a cookie. Using this method, a single user may be “logged in” from many computers simultaneously (e.g., from work and from home).

A user currently logged on to the system has an ever-present button on his interface that signs him off from the system. When the user signals the server system to “log off”, a blank cookie is sent to the user's browser to replace his session key. Without the session key, the system will no longer automatically identify the user at that web browser. Note that the session key cookie is deleted from one particular computer, but not from other computers from which the user might be logged in. A user signed on from work and from home may log out at work, but his home computer will retain the session key cookie; thus, the user is still logged in from home.

Interface screens employed to present the contents of objects (documents, groups, e-mails, etc.) to the user can be grouped into two abstract categories: detailed (singular) context and list (plural) context. In a list context, a table is rendered on the interface screen, displaying many objects simultaneously. Each object spans one or more table rows, while columns are attributes in that object class. For instance, a list view could be constructed for user objects in which the user name, first name, and business telephone number are displayed. A table would be constructed with a row for each user object in the system, headed by columns titled “User Name”, “First Name”, and “Business Telephone Number”. In a detailed context, an interface page is rendered to describe a single object in detail. From the detailed perspective, the user may perform a number of object-specific actions that may only hold meaning for the particular class of object. For instance, a detailed view could be constructed for a user object which would present all of the user's attributes in a single screen for reference, or if the user interacting with the system was looking at his own user object, the same interface could be used to change some of the parameters (e.g., e-mail address, telephone number, etc.)

The list context interface displays a list of database objects in summary form. From the list view, one can change the order of presentation of objects by sorting the list with primary, secondary and ternary sort criteria. One can also perform general searches for words or phrases that might appear in any of the attributes, and one can limit the list to those objects with attribute values that meet certain criteria specified with Boolean logic. Using some combination of sorting, searching, and limiting, the user can narrow the scope of the listed objects to those of most interest.

One chooses how the list of objects will be sorted by selecting up to three attributes to use as sort keys: primary, secondary and ternary attributes, shown as the column values in the list table presented to the user. Different attribute types have different sets of sorting rules: alphanumeric, numerical, chronological, etc. Lists are first ordered by the sorting criteria for the primary sort attribute. When two or more objects are found with identical values in the primary sorting attribute, so that they cannot be ordered, sorting is performed on those objects according to the rules for the secondary sort attribute. If two or more of these objects still contain identical values, the ternary sort attribute rules are used to sort those objects.

In the present invention, many objects can be indexed with unique values, such as identity tags or unique names. When an attribute with a domain of unique, non-repeating values, is selected as a sort criteria, further sorting of the list will yield no effect. For instance, if a list of documents is to be sorted primarily by identity tag, secondary or ternary sorting criteria will have no effect on the sorted list because all of the values of the primary sorting attribute are unique.

The list of objects presented to the user can be reduced in size through a limiting (or searching) operation that queries the object database for objects matching certain criteria. Queries are constructed using combinations of relational and logical operations on values in objects or values in other objects. Logical operators include, but are not limited to, AND, OR, EXCLUSIVE-OR (XOR), and NOT. In conventional usage, logical operators act to combine two or more relational operations. Relational operators include, but are not limited to, EQUAL, NOT EQUAL, LESS THAN, GREATER THAN, LESS THAN OR EQUAL TO, and GREATER THAN OR EQUAL TO. Queries can also uncover sub-string matches. The general search function is a simple case of the limiting function in which a query is performed looking for a simple substring in every value of every object.

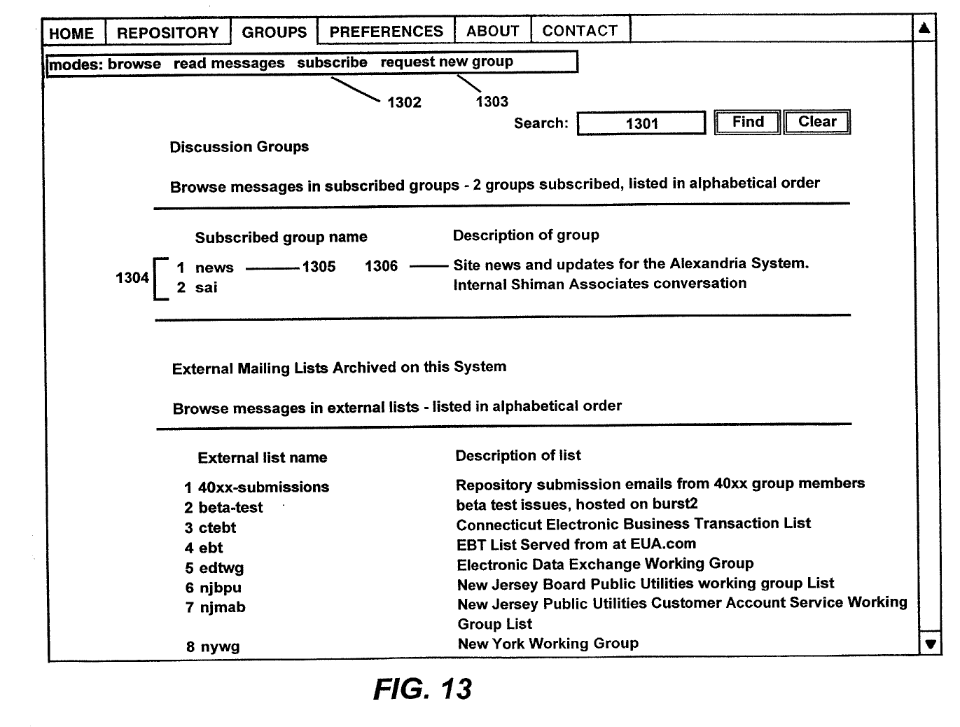

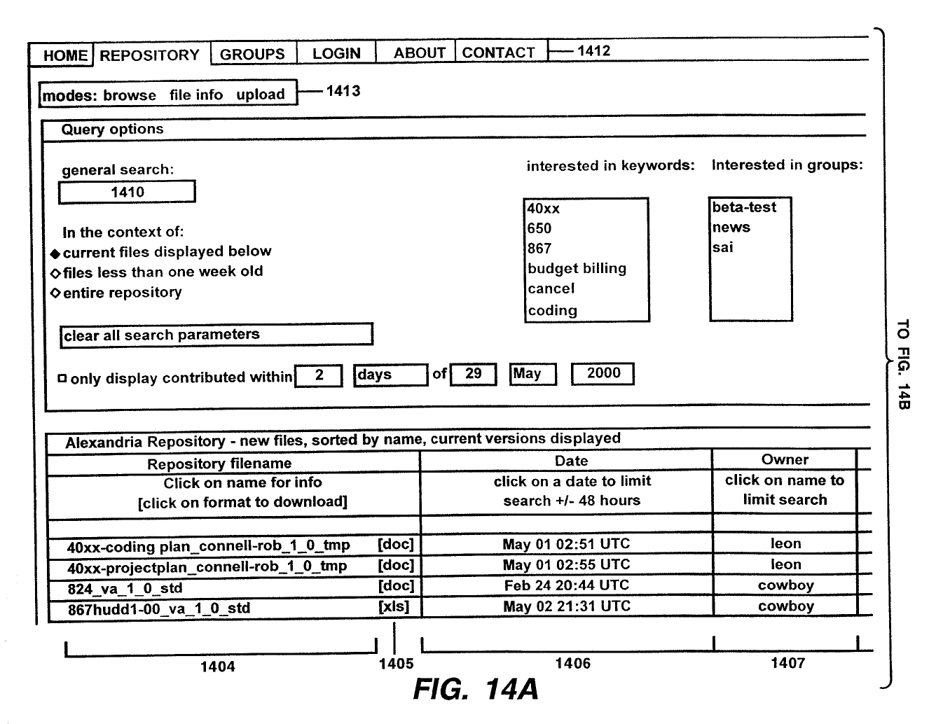

FIG. 13 is a list-context interface screen that enables selection and manipulation of a list of discussion groups. Groups act to limit access to documents stored in the repository, and to qualify and control access to the archive of e-mail conversations on the web. Users conducting conversations by employing the electronic mailing lists managed by the server can re-visit e-mails in these conversations by employing the web discussion group archive interface. From the interface of FIG. 13, a user may browse the list of discussion groups to which he belongs to select a single discussion group to view in detailed context. That is, the user intends to read archived e-mail messages in a single group—this functionality is the list-context e-mail view, equivalent to the detailed context discussion group view.

Shown in FIG. 13 are: a general search box 1301, a subscription management button 1302, a new group request button 1303, and a list of discussion groups 1304. One discussion group is listed per row, showing a group name 1305, and a one-line group description 1306. The discussion groups in the list 1304 are those of which that the viewing user is a member. Users may invoke a detailed view of a single discussion group by selecting the group name 1305.

Generally, users do not belong to so many discussion groups that they need a sort/search mechanism on the group objects themselves. The list 1304 is presented in alphanumeric order by group name. The general search function 1301 is therefore a search on all of the e-mail messages related to the subscribed groups.

The new group request button 1303 invokes an interface screen allowing users to request the creation of new discussion groups, to be discussed below. Users may subscribe to groups of which they are not members, or they may delete their membership from subscribed groups by using the subscribe/unsubscribe interface screen invoked through the subscription management button 1302.

FIG. 14 is a list-context interface enabling the manipulation and summary view of many document objects simultaneously. Forming the interface screen are a query interface 1401, a sorting interface 1402, and a document object summary list 1403. Documents shown in the list 1403 are related to the discussion groups of which the viewing user is a member. Documents not shown in the list 1403 are withheld from the viewing user because the user lacks membership in the groups related to the withheld documents. Searches and sorting operations using interfaces 1401 and 1402, respectively, take into account the withheld documents.

The list display 1403 provides a summary view of document objects. Shown in the list 1403 for each document object are the identity tag 1404, available format tags 1405, modification date/time 1406, the document owner 1407, related groups 1408, and related keywords 1409. Users can select a detailed context view for each document in the list by clicking on the identity tag 1404. Detailed contexts can also be entered for the user object of the owner 1407, the discussion group 1408, and the keyword object 1409 in the same manner, by clicking on the respective name. Clicking on a format tag name 1405 related to a document object will invoke the download process for the selected format of the document object.

Due to the potentially great number of documents in the database, the document list context incorporates flexible sorting and limiting capabilities. Using the sort interface 1402, a user may order the list by assigning primary, secondary, and ternary sort key attributes from among the attributes: identity tag, date, owner, and authcode. Each object is uniquely identified by the identity tag, and, to a certain extent, the date. It is relatively unlikely two files will have the same date assigned by a clock having a one second granularity. Therefore, there are 10 general types of sorts that can be performed on this screen: by identity tag, by date, by owner then identity tag, by owner then date, by authcode then identity tag, by authcode then date, by owner then authcode then identity tag, by owner then authcode then date, by authcode then owner then identity tag, and by authcode then owner then date. In addition, each sort can be conducted in reverse order as well, increasing the number of possible sorting methods to fifty-two.

The query interface 1401 can be used to search on the document objects or limit the display of objects. As with other objects, a general search option 1410 enables the possibility to search for sub-strings across all database attributes in every viewable document object. The limit/query interface 1411 allows a number of advanced capabilities. In the preferred embodiment, the query interface is replicated as an editable line of text that can be parsed for Boolean keywords and relationship operators, as well as a sequence of buttons and fields. The list of objects may be limited to queries performed with Boolean algebra relations between attributes containing substrings or satisfying relationship operators: keywords, groups, owner, authcode, and a range of dates.

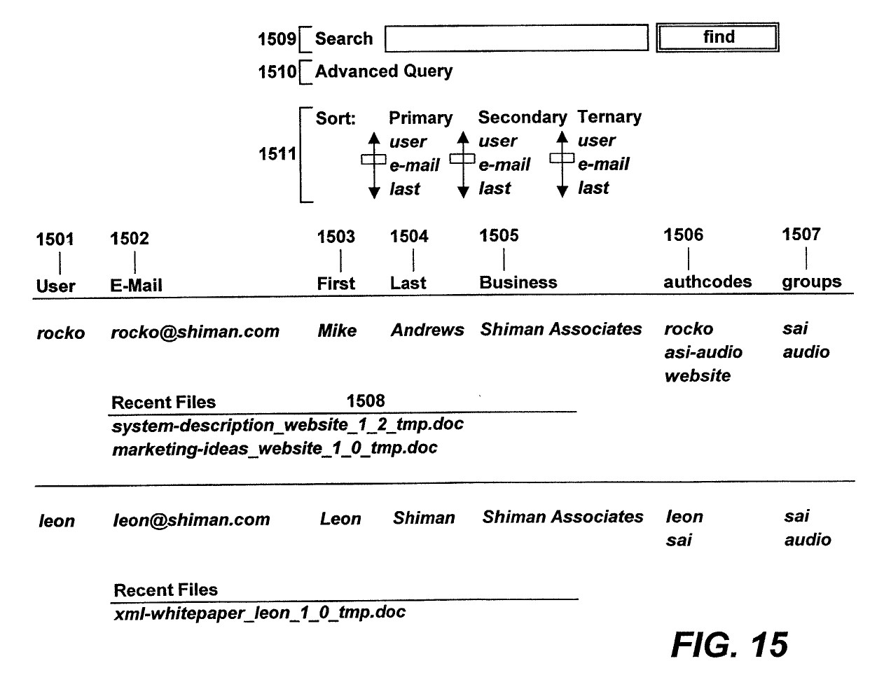

FIG. 15 shows an interface for list context view of user objects. From this interface, one may obtain or cross reference the user name 1501, e-mail address 1502, first name 1503, last name 1504, business name 1505, authcode(s) 1506, group(s) of those the viewing user is participating in 1507, and recently modified documents owned by the user 1508. For privacy, the telephone numbers of each user aren't shown on this list, and each user object is displayed only if it has a relation to one or more of the viewing user's subscribed groups.

The list of users may be searched using the general search function 1509, limited using the query function 1510, or sorted by primary, secondary and tertiary attributes 1511.

From this interface, users may identify other users who participate in the same groups. Of particular interest is the mapping from user name 1501 to authcode 1506, allowing users to identify who is responsible for certain content in the document repository. Selecting any authcode will invoke a list-context view of the document repository objects related to the selected authcode. Selecting any discussion group name 1507 will invoke a detailed context view of the selected discussion group. Selecting a user name 1501 will invoke a detailed context view of the user object with that name. Selecting the e-mail address 1502, first name 1503, or last name 1504 will instruct the client's web browser to begin an e-mail letter addressed to the selected user. Selecting document identity tags 1508 will invoke a detailed context view of the document. To reduce the size of the list, the number of related documents shown 1508 has been limited; this number can be adjusted in the query interface 1510.

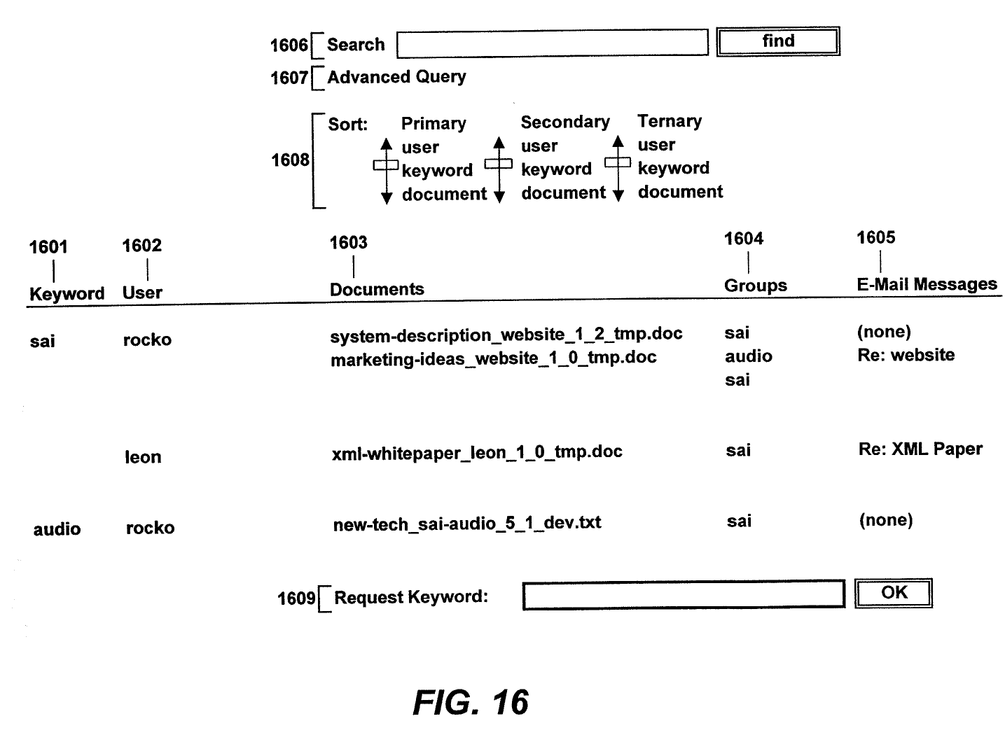

FIG. 16 shows the interface of a list-context view of keyword objects. From this interface, one may cross reference keywords 1601 with users 1602, documents 1603, groups 1604, and e-mail messages 1605. The list of keywords may be searched by using the general search function 1606, limited by using the query function 1607, or sorted by using primary, secondary and ternary attributes 1608.

The keyword list context exists to enable easy access to the detailed context views of the other system objects. Selecting the related name of any object 1601 through 1605 invokes the detailed context view of that object. New keywords can be requested by using the keyword request field and button 1609. Pending review by the system administrator, requested keywords are inserted into the database. If, later, some keywords are determined to offer little or no value, those keywords may be deleted.

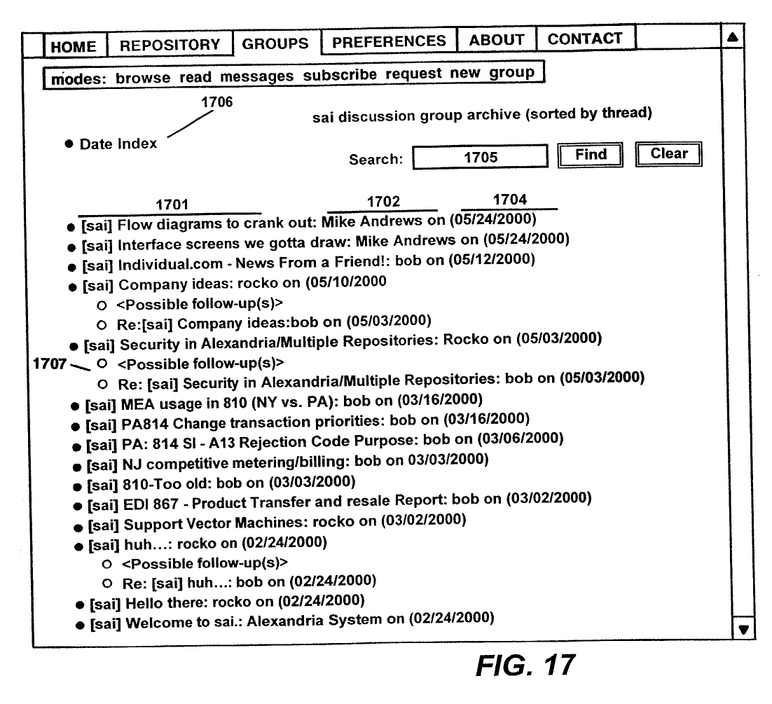

FIG. 17 shows an interface for a list context view of electronic mail objects. From this interface, a user is shown an overview of conversations taking place within a particular discussion group. Shown on each line of the table are values of attributes in an individual e-mail object: subject 1701, author's name 1702, and the date received 1704. The list of e-mail objects may be searched by using the general search function 1705, limited by using the query function (not shown), or sorted by primary, secondary and ternary attributes 1707.

The list of e-mail objects may be sorted by time received, by author, and by subject with the sorting interface 1706. If sorted by subject, a staggered presentation is possible 1707 in which the e-mail objects are indented to reflect their hierarchical position in the conversation. In the staggered view, a new conversation thread begins flush with the left margin; replies to the original e-mail are indented once, and each reply to the first reply is indented twice. Neither the author nor the subject offers unique identifiers for e-mail objects, but within a one-second granularity, the receipt time for an e-mail message is unique. The complete set of all applicable permutations of e-mail object sorting methods is: by date, by subject, by author, by author then subject, by subject then author, by subject then date, by author then date, by author then subject then date, and by subject then author then date. Typically, the date is used as a final sorting order.

Selecting a subject string 1701 will invoke a detailed view of the container e-mail object. Selecting a user name 1702 will invoke a detailed context view of the user object with that name. Selecting the e-mail address, first name, or last name (all shown as 1703) will instruct the client's web browser to begin an e-mail letter addressed to the selected user. The e-mail list context is also the discussion group detailed context when all of the e-mail objects listed belong to the same discussion group.

The detailed context interface displays a single database object in detail. In general, the interface screen is a table of some form, populated with all of the values contained by the object under detailed view. Even values that may have been excluded from the list context display are shown in the detailed context. The detailed view interfaces for each object class are presented below.

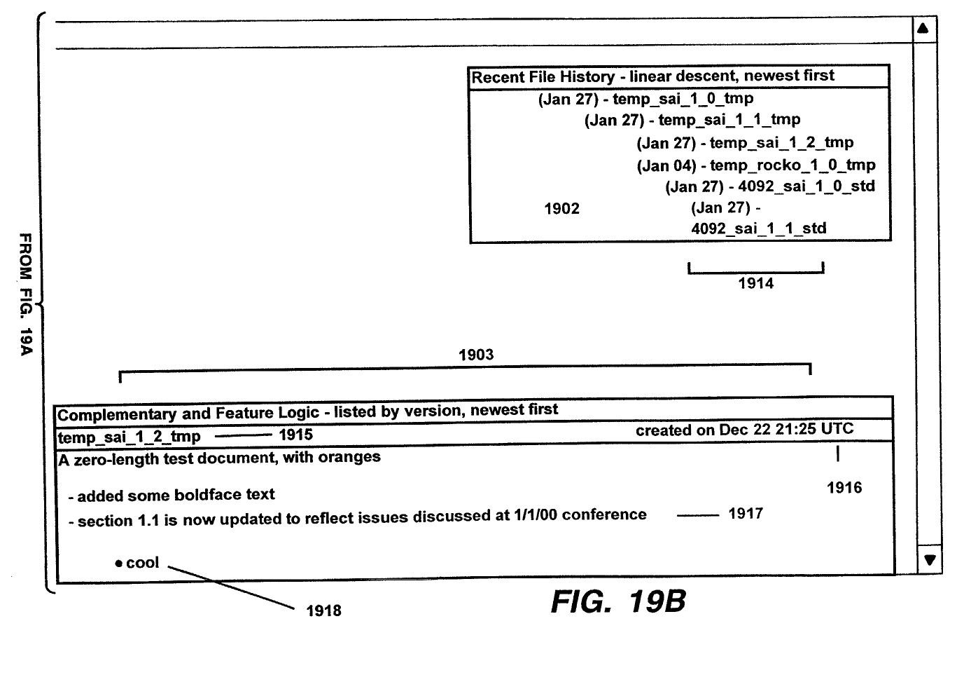

FIG. 19 depicts an interface screen that provides a detailed context view of a single document object. The screen is divided into three sections: the attribute table 1901, the ancestry history tree 1902 and an annotated ancestry display emphasizing linear descent 1903. Users viewing this interface screen see all values of attributes in the document object and the development history of the document.

The attribute table 1901 enumerates the various attributes and values of the document object, including its owner 1904, related groups 1905, related keywords 1906, available format tags 1907, its description 1908, and its feature logic 1909. For each object relationship displayed, selecting the name of the related object (e.g., user name 1904, group 1905 and keyword 1906) invokes the detailed object view for the selected object. Selecting a format tag 1907 initiates the server-to-client download process for the document's content in the selected file format.

When the viewing user is identified as the document owner, several other options appear in the attribute table 1901: the ability to change the status of the document through the new status field and button 1910. Also present is a group of buttons allowing an automatic, server-side generation of new available format tags for the document (not shown). The content and actions of the generate format group (not shown) depend on the native source format tag of the document as contributed by the document owner. Those skilled in the art will appreciate that not every allowable format can be translated to every other allowable format with high fidelity to the original; certain formats are feature-deficient relative to other formats. A mapping of the effects of format-to-format translation is continuously changing as technology grows and new formats are created. Also present for the document owner is an upload button 1912 allowing the owner to upload changes to this document.

The notification mechanism 1913 is not present when the interface screen is viewed by the document owner because the document owner is the only user allowed to change the document. For non-owners, the notification mechanism 1913 is a toggle switch allowing users to change their notification status for the particular document.

Modification history of the document is revealed through the ancestry history tree 1902 and an annotated ancestry display emphasizing linear descent 1903. With parent-of-record relationships in document objects, the system constructs a hierarchical tree-view of the entire document database. Nodes in the tree view are identity tags 1914. The ancestry tree display 1902 is a window into a small area of the overall, system-wide ancestry tree; it centers on the current document's position in the tree. From any given node (identity tag) in the tree, a document's parents and children are revealed. In the preferred embodiment, the tree displays in a staggered fashion, with a node's parents above and to the left and a node's children below and offset to the right. In other embodiments, the tree is drawn in a vertical configuration (parents above, children below each node) with lines connecting the nodes of the tree. Navigation to other detailed context views is possible with the ancestry tree: selecting an identity tag 1914 invokes the detailed context view of the related document.

A linear descent history is formed by recording the document identity tags along a single path from the current, in-focus document, towards the head of the ancestry tree. The recorded list is sorted by modification time with newest entries shown first. In the linear descent history section 1903, a multi-line block is devoted to each document that displays the identity tag 1915, modification time 1916, description 1917, and features 1918. By way of example, a third generation document would show a three-element linear-descent list comprised (in order) of itself, its parent, and the parent's parent. As noted previously, the identity tag name 1915 can be selected to invoke a detailed context view of its related document.

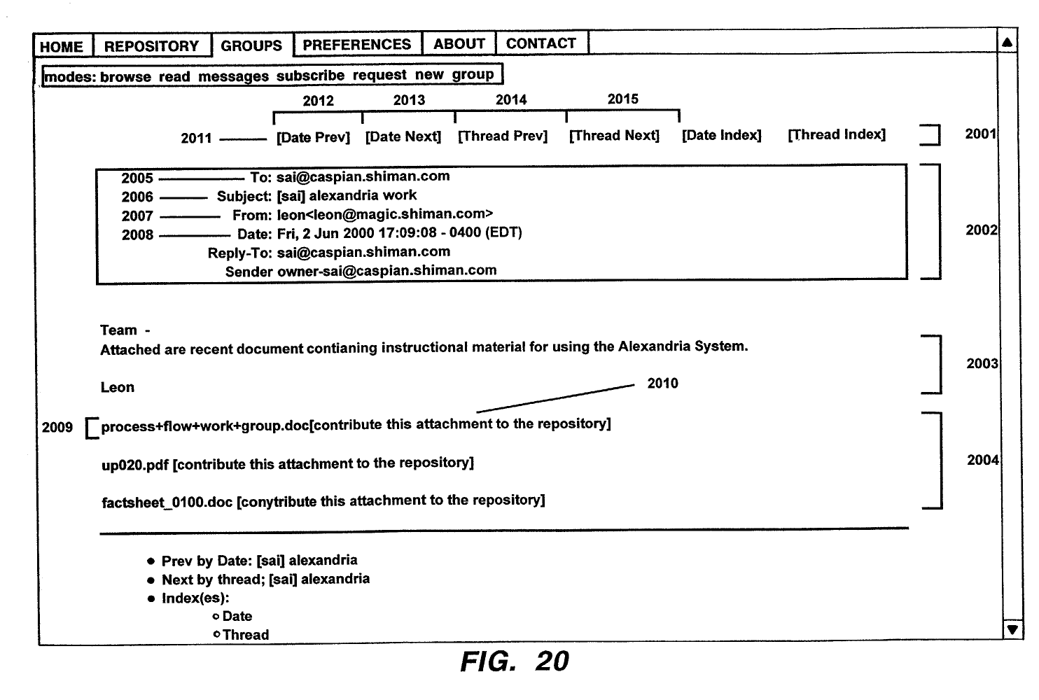

FIG. 20 is a detailed context interface screen tuned to the display of electronic mail message objects. The display is segmented into four components: navigation 2001, e-mail header 2002, e-mail body 2003, and e-mail attachments 2004. The header, body, and attachments are all derived from the original e-mail message. Other e-mails in the discussion group are brought into focus via the navigation menu.

The e-mail header 2002 is a formatted representation of the original message header, as specified in Internet RFC 822. Attributes and values from the e-mail object are shown in tabular form. Shown are the discussion group name 2005, subject 2006, the sender's electronic mail address 2007, and the e-mail receipt time at the server 2008. In the header and in every other instance in this interface screen, users may select an e-mail address to compose an e-mail message directed to the selected address. Selecting the group name 2005 invokes a detailed context view of the selected discussion group.

The e-mail body 2003 shows the plain text portion of the e-mail message. Within the body, URLs and e-mail addresses are reader-selectable; in the present invention, this is accomplished with hyperlinks. A user may select a URL to direct his web browser to the specified URL. The body of the e-mail object may be searched by the server system to match names corresponding to database objects. Keyword names, identity tags, user names, and group names can be found with a substring search in the message body, matching each unique name in the database with a substring in the text. However, some names that are unique to the server database may not be unique in casual electronic mail messages. Often, e-mail messages present contexts quite different from the one the user is expecting. Thus, a keyword uncovered in such an e-mail message may be misleading to the reader. With this keyword, group, user, and document name discovery function enabled, name matches appearing in the text are reader-selectable, capable of invoking detailed context views of the selected object.

MIME-format attachments 2009 are shown in an interface at the end of the e-mail body. Attachments can be documents or other binary media files that aren't easily represented in plain text. They can be downloaded individually to the client system by selecting the attachment name, or they can be individually contributed to the document repository as if they were uploaded by selecting the contribute-to-repository button 2010 for each attachment.

Using the navigation interface 2011, users may view other messages that are chronologically near the current message. Previous message by date 2012 and next message by date 2013 buttons allow navigation to messages received earlier or later, respectively, than the present message. Previous thread 2014 and next thread 2015 buttons allow navigation to different subjects of discussion. In this context, the previous thread button 2014 tracks backwards in time through the e-mail messages in the current group until a different subject is found; the first message in such a subject is selected for view. The next thread button 2015 tracks forward in time from the current message until a new subject is found, selecting the first e-mail in that subject thread for view.

User objects are shown via two interface screens. If the viewing user (i.e., the user who is viewing the object with the interface) is viewing his user object, he is shown an interface that enables him to change various values about himself (e.g., e-mail address, telephone number, etc.). If the user is viewing another user's object, he is shown a different, read-only interface, comprised of public information from the user object. Viewing others' user objects primarily reveals connections between user name, real name, and authcodes.

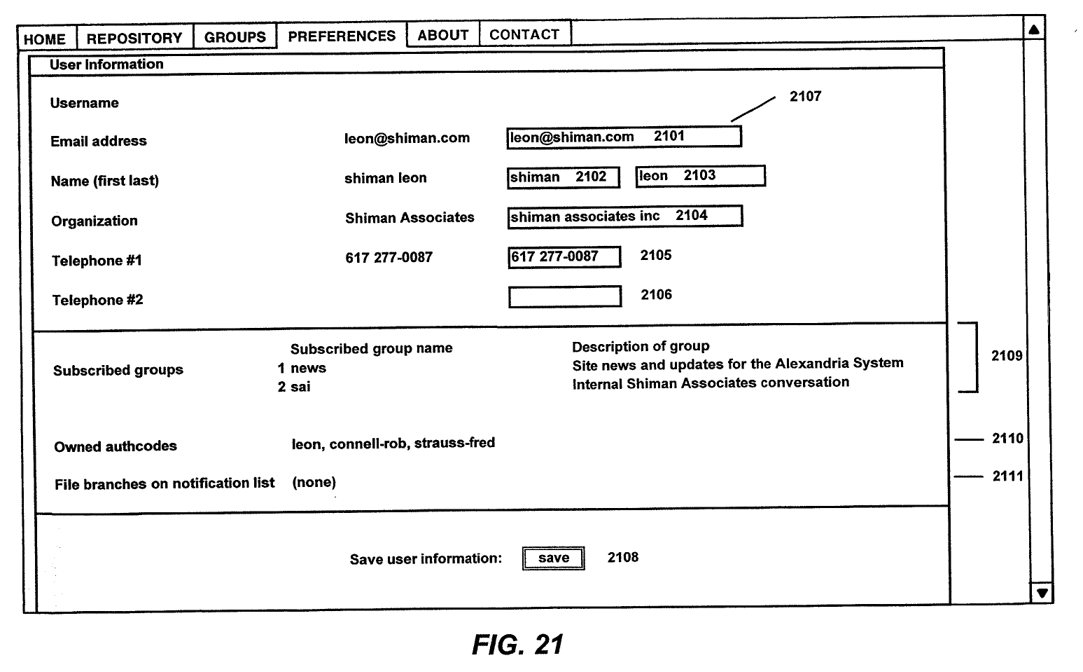

FIG. 21 is a detailed context interface that enables a user to modify his user object. This interface is available only to the owner of the user object and to the system administrators. The interface shows six user information parameters: Internet e-mail address 2101, first name 2102, last name 2103, business or organization 2104, telephone number one 2105, and telephone number two 2106. Parameters can be modified by altering the value present in the edit field 2107 corresponding to each attribute; the information is stored in the user object when the save button 2108 is selected.

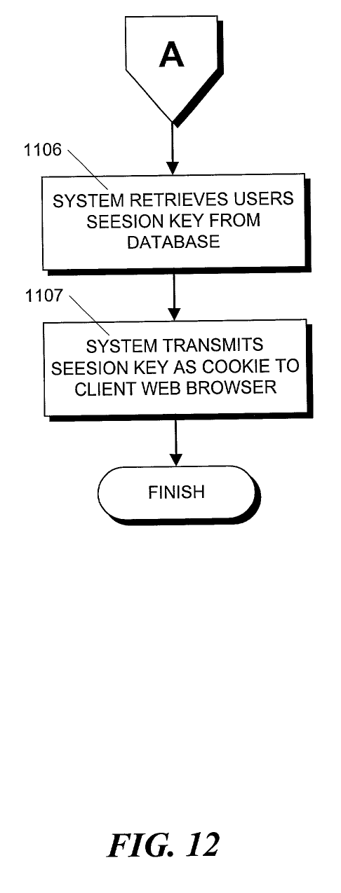

Several useful list-context views of related objects are shown in the interface of FIG. 12: subscribed groups 2109, owned authcodes 2110, and the document branches on notification list 2111. The group names in the subscribed groups list 2109 can be selected to invoke a detailed context view of the named group. In addition, the branch tags in the notification list can be selected to invoke a detailed view of the newest document in the named branch.

The interface designed for viewing others' user objects appears similar to FIG. 12, although it lacks the edit fields 2107, the telephone numbers 2105 and 2106, and the document branch notification list 2112. In addition, the viewing user is shown a subset of the complete list of subscribed groups 2109. The new list is formed from groups subscribed to by both the user described by the user object, and the viewing user.

The detailed context view of a discussion group is primarily the list context view of electronic mail messages related to the discussion group. Although discussion groups are also related to documents, keywords, and users, the collection of related electronic mail messages dominate the utility of a group-centric interface. The list-context e-mail interface is described below.

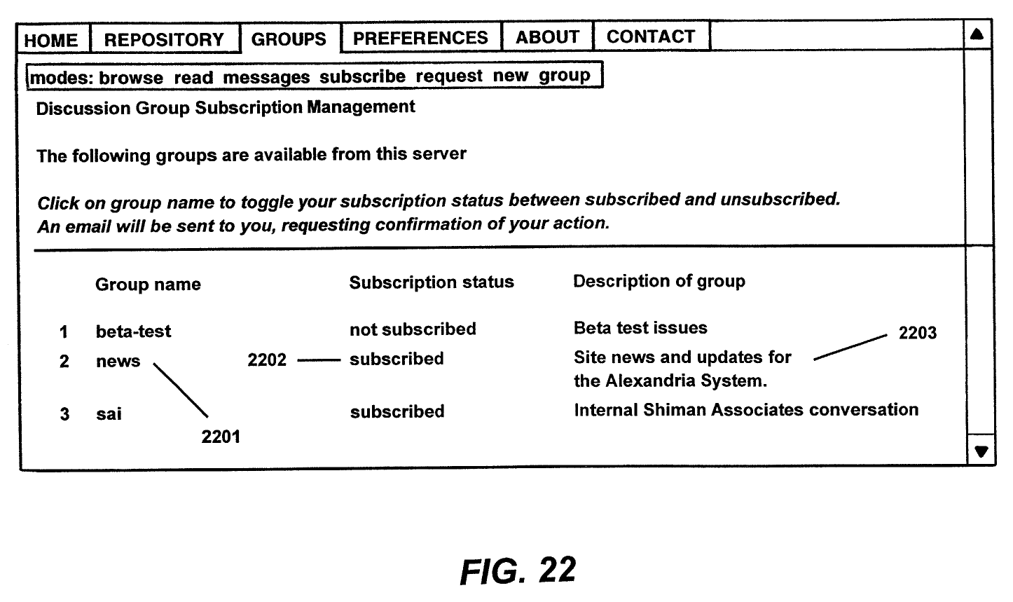

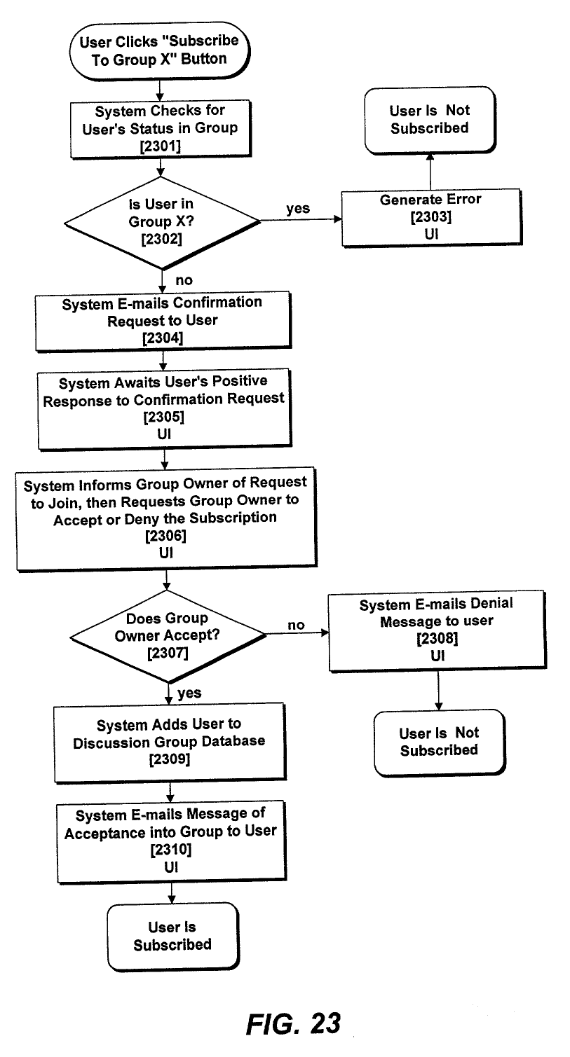

Users of the system may request membership to discussion groups they in which they do not currently participate. In general, there are two reasons for making such a request. First, a user may require access to certain documents in the repository that are currently unavailable to him. Second, a user may wish to participate in the group's discussion using the electronic mailing list functionality. The request to join a group is made with a subscription management interface, shown in FIG. 22, and described by the process flow diagram in FIG. 23.

FIG. 22 is a list-context view of discussion groups that allows a user to toggle subscription status for any group. The list comprises discussion groups in the system that have no special restrictions. Excluded from the list may be certain private discussion groups closed to membership and certain mandatory discussion groups from which a user may not delete himself. Other embodiments of the invention may offer additional special cases. For each list entry, the list reports the group name 2201, subscription status 2202, and a brief one-line description of the group's purpose 2203.

Subscription status is toggled by selecting the desired group name 2201. FIG. 23 describes the process flow that occurs when a group that the user is currently not subscribed to is selected for subscription. In 2301, the system queries the user database for the user's subscription status in the specified group, “group X”. In 2302, if the user is already a member of the group, he may not become a member again; therefore, an error is generated 2303 and the user isn't subscribed.

If the user isn't a member of the group, the system sends an action confirmation request to the Internet e-mail address of the user. The user is required to confirm that he wishes to become a member of the group. The system marks the user's subscription status to this group as pending, awaiting the user's confirmation 2305. If confirmation is never received, no action is taken.

Upon receipt of the user's subscription confirmation 2305, the system sends an e-mail message to the group owner informing him of the user's request to join 2306. The letter requests that the owner confirm or deny this user's membership. If no action is taken by the group owner at this point, the user will remain unsubscribed indefinitely. If the group owner rejects the user's membership 2307, the system sends an e-mail message to the user notifying him of the denial 2308.

If the group owner accepts the user's membership 2307, the user is inserted into the group's membership list by relating his user object with the group object 2309. Subsequently, the system e-mails a letter of acceptance to the user 2310.

In interactions with the web interface of the preferred embodiment, a user may request to download a document from the server system. Specifically, users may begin a download procedure for a document in one of its available formats from the document list-context view, and from the document detailed-context view. The download mechanism is a variation of the standard WWW request process described above and in FIG. 6. Specifically, a file rather than a page will be served to the client system if the request is fulfilled. The difference between a downloaded file and a page is in its MIME content-type. Typically, downloaded files are marked with a type such as “application/octet-stream” that will not be handled by the client web browsing software program; instead of displaying the file to the user, the web browser must save the file to disk.

As in the process described in FIG. 6, access is granted to the file depending on the user's group memberships and the file's group relations. The server system may refuse to transmit the file to the user if he does not meet the security criteria.

Users may update the status code of documents they own. The user interface is shown in FIG. 19 with a change status code entry field and accompanying button 1910. To change the status code, a user enters the desired new status code into the entry field of 1910 and selects the attached change status button 1910. A new document object (new status document) is created for each status code change, preserving the identity tag except for the modified status code. The new status document object will contain all other information from the old document. In the ancestry tree, the new status document object will indicate the old document as its parent of record. One skilled in the art will appreciate that the actual document content file need not be copied; it may be symbolically linked if it resides on a file system that supports the feature (e.g., UNIX).

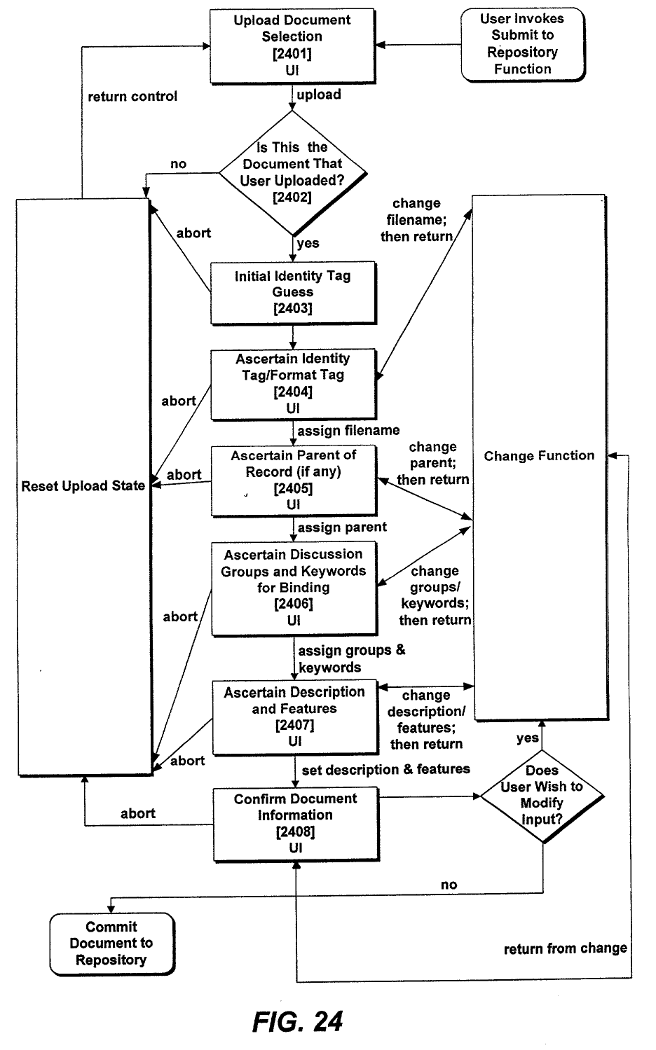

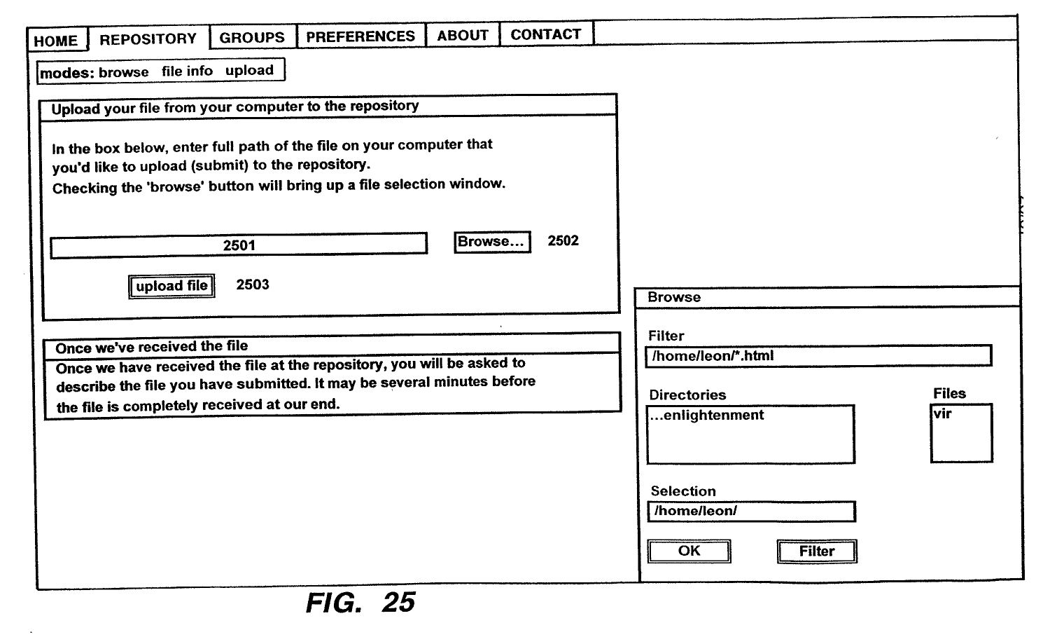

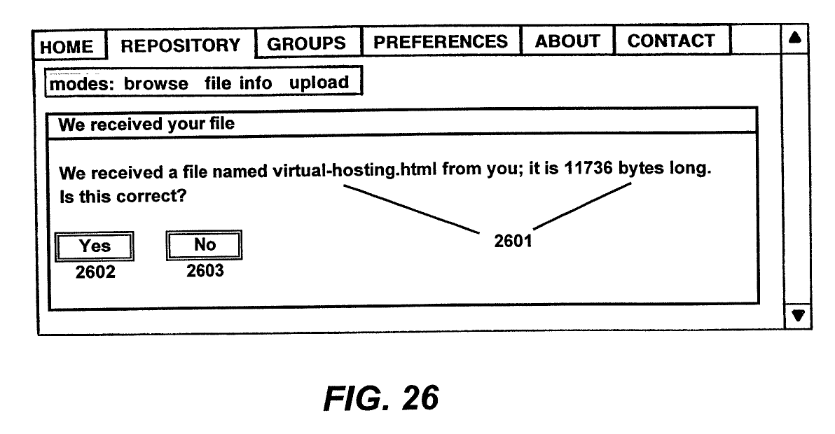

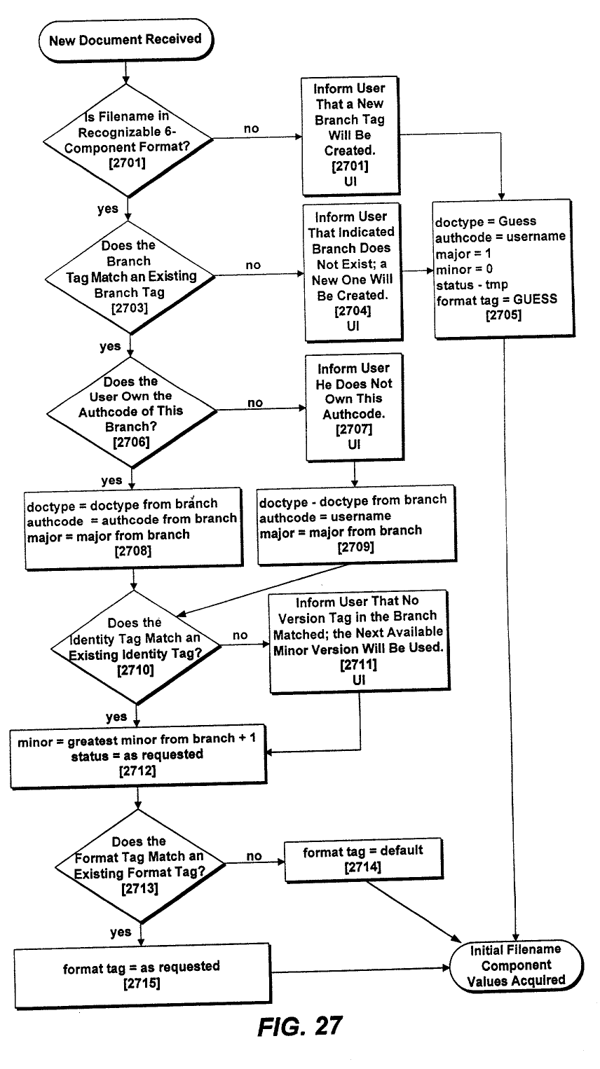

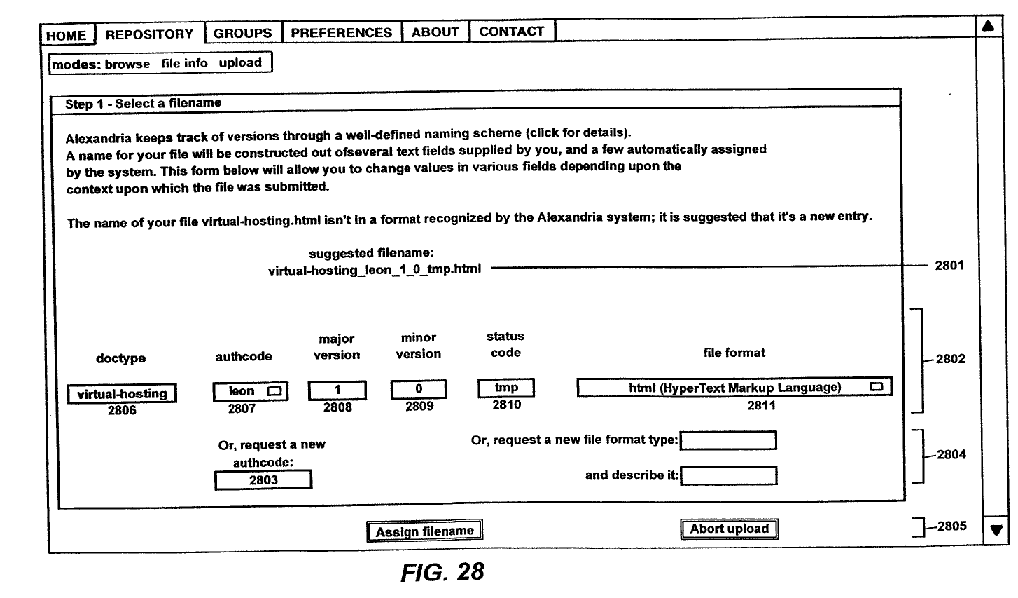

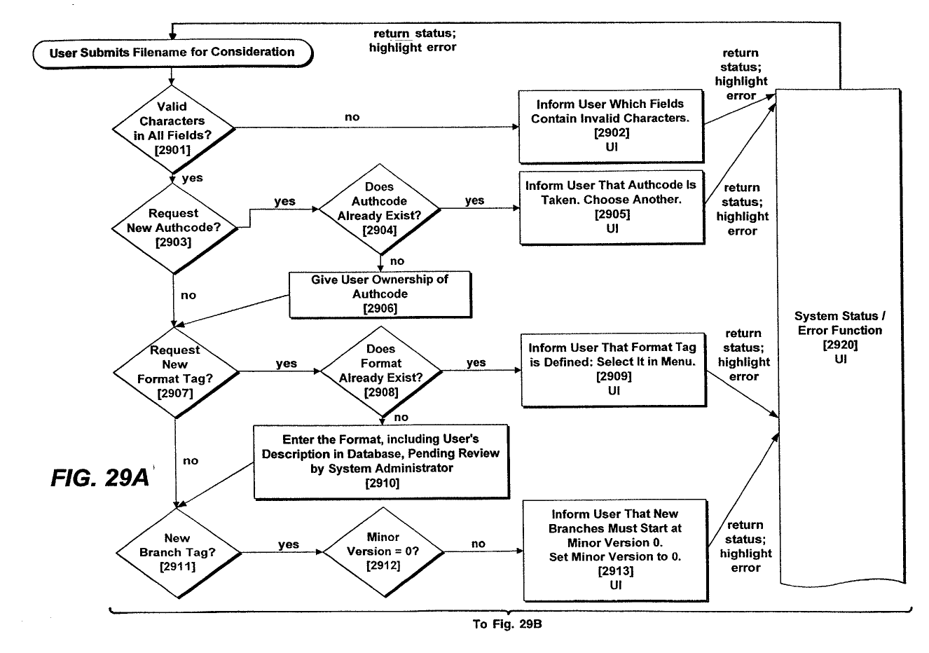

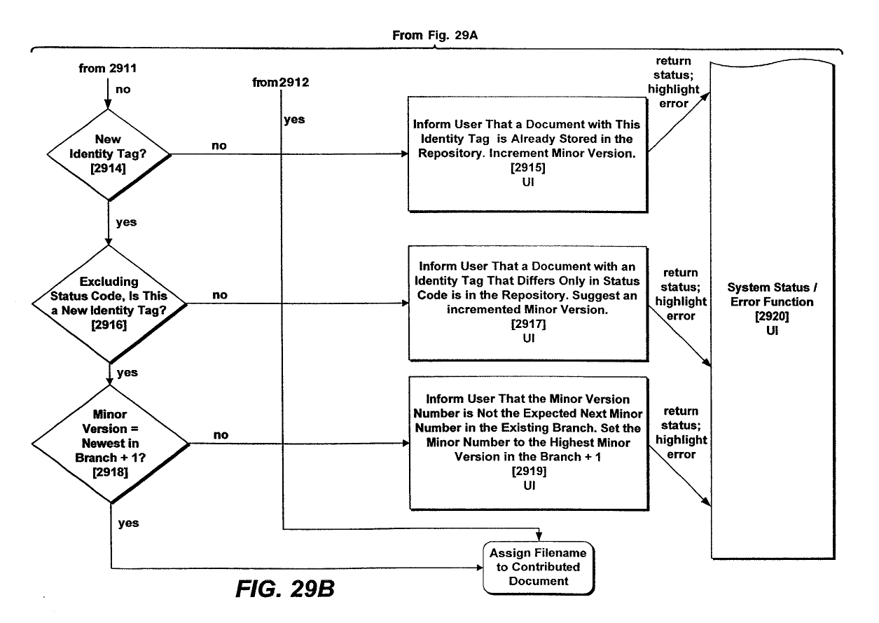

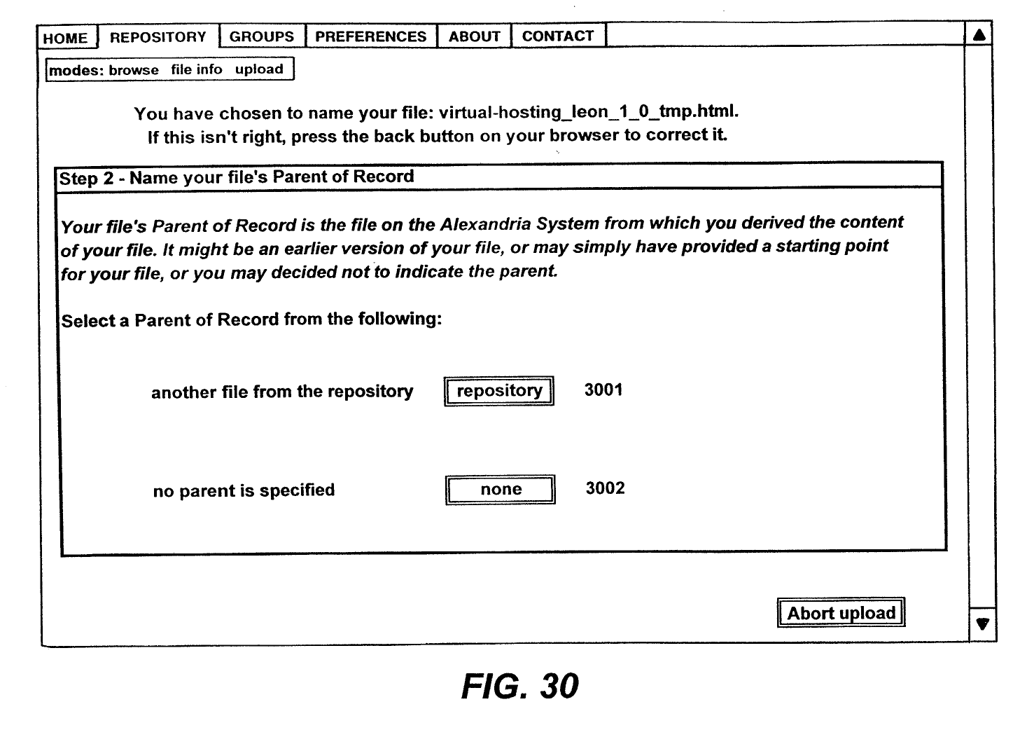

The following paragraphs describe the processes and interfaces involved in user contribution of documents to the document repository on the server system. The processes are described in FIG. 24, FIG. 27, and FIG. 29. Seven interfaces are described in FIG. 25, FIG. 26, FIG. 28, and FIGS. 30 through 33.

The upload process begins when a user selects the submit-to-repository functionality from either the document detailed-context view or the document list-context view. FIG. 24 describes an overview of the process of contributing a file from its upload to its document object creation. First, the user is asked to choose a file to contribute to the document repository from those residing on his client computer system 2401. Second, the user confirms that the file received by the server system is valid 2402. Third, the system derives an initial guess for a unique identity tag, based on the filename of the uploaded file 2403. Fourth, a unique identity tag is assigned to the file by the user with assistance from the system 2404. Fifth, the user assigns parent(s) of record to the file 2405. Sixth, discussion groups and keywords have relations to the file 2406. Seventh, the user creates a plain text description and feature list 2407. Finally, the user is asked to confirm all information created during the process; he is also given the option to change the information 2408.

Upon successful completion of the upload process, the information is stored in a new document object, and the specified relations to other system objects are formed. The uploaded file is assigned the unique identity tag, and a reference to its location in the server's file system is hooked into the document object.

In step 2408, the user may elect to change information entered on any one of the seven interfaces. If a change is desired, control passes to the interface where the change must be made. After the change is made, control returns to step 2408. In the contribution process from step 2403 on, the user may elect to abort the process. If so, the state of all parameters related to the contribution process is reset, and control returns to step 2401.

FIG. 25 is an interface screen that enables the user to specify a file to contribute to the document repository from among those residing on his computer. There are three components: a file path name field 2501, a web browser “browse” button 2502, and an upload file button 2503. A file located in a storage device in the user's computer must be specified by its full pathname. Typically, this name includes the name of the storage device, zero or more hierarchical directory names, and the file name. The browse button 2502 serves to aid the user in his selection of a file. It invokes a web browser-dependent file selection interface; in one browser, it is a window with two panes: one allowing selection of the storage device and a path, the other allowing selection of a file within a path. The browse operation leaves the resulting chosen file name in the file path name field 2501.

Once a file has been specified in the file path name field 2501, the user may select the upload file button 2503. If no filename is selected, and the user selects the upload file button, no action is taken. The upload button 2503 transmits the file from the user's computer to the server computer. Control is passed to 2402.

FIG. 26 is an interface screen that requests the user to confirm that the file received by the server computer system is valid. It contains text reporting the name and length (in eight-bit bytes) of the file received 2601. The user must confirm the file by selecting the “Yes” button 2602, or invalidate the file by selecting the “No” button 2603. If the user invalidates the file, the received file is deleted and control returns to step 2401. If the user confirms the file, control passes to 2403.

Before an interface is provided to the user to assign an identity tag, the server system software forms an initial guess at the identity tag, based on the name of the uploaded file. FIG. 27 describes the process used to derive the initial guess. Documents that have been downloaded from the server computer system will carry their identity tag and format tag as the filename. It is intended that the client user keep this file name during any editing process so as to enable the server system to easily identify the file, if it is uploaded to the server system again.

In step 2701, the server tests the file to determine if it is in the recognizable six-component format of doctype, authcode, major version, minor version, and status separated by underscores (_) followed by the format tag (set apart from the identity tag by a period.) If it is not, the user is informed that a new branch will be created for this file 2702. In this case, the initial identity tag is formed from the following: the doctype is assigned to the first eighteen valid characters from the uploaded file name, the authcode is the user's user name, the major version is one (1), the minor version is zero (0), the status is “tmp”, and the format tag is inferred from the file extension of the uploaded file 2705.

If the received filename appears to be in the appropriate six-component format, the server system, in step 2703, tests the branch tag derived from the file name (its purported doctype, authcode, and major version) against branch tags existing in the database. If the branch tag doesn't exist, the file name is assumed to be bogus 2704: filename components are chosen as in step 2705.

If the branch tag exists in the database, its authcode is tested to reveal if the uploading user is its owner 2706. If the user does not own the authcode, he is informed 2707, and the authcode is set to the user's user name 2709. If the user does own the authcode, the authcode is retained 2708. Regardless of the outcome, the doctype and major number from the derived branch tag are retained 2708.

In step 2710, the database is queried to find a match for the full identity tag as derived from the uploaded file name. The simple case occurs when the uploaded file is an update of an existing document in the server system. In this case, the uploaded file's identity tag matches one in the database; the tag is preserved, except for the minor version number, which takes on the greatest minor version number in the branch, plus one (1) 2712. Otherwise, the uploaded file's identity tag can't be found in the database. This outcome is the same as above 2712, although the user must be notified that the identity tag wasn't found 2711.

In step 2713, the database is queried to look for the derived format tag. If the format tag isn't found, it is set to the default (typically “doc”) 2714. If the format tag is found, it is preserved 2715. The server system now has an initial guess for the identity and format tags.

In FIG. 28, the user is shown an interface that allows him to change the identity tag and format tag of the uploaded file. The interface comprises five sections: the suggested filename (from identity and format tags) 2801, the identity tag and format tag entry fields 2802, a new authcode request field 2803, new file format tag request fields 2804, and assign/abort buttons 2805. Initial values for the identity tag and format tag entry fields 2802, as well as for the initial suggested file name 2801 are derived from the process explained above and in FIG. 27.

The identity tag may be modified by the user through the interface. Components of the identity tag are shown in discrete entry fields: doctype 2806, authcode 2807, major version 2808, minor version 2809, and status code 2810. Likewise, the format tag is modifiable through its own field 2811. The user changes information in the fields in order to form the desired identity tag. In many cases, the initial identity tag derived above will suffice. Should the user require a new authcode, one may be created using the authcode request field 2803. Should the user require a new format tag, one may be created using the format tag entry fields 2802; in creating a new format tag, the user supplies both the tag and a short description.

Once the user has completed all applicable information in the interface of FIG. 28, the assign filename button 2805 may be selected. FIG. 29 shows the error checking and correction process for the user-supplied identity and format tags. The interface and underlying process are designed to loop on error, shown as the system status error function 2920. If the identity tag and/or the format tag created using the interface of FIG. 28 fail the tests in the process of FIG. 29 at any point, an error is reported to the user, a corrected identity tag and format tag are formulated, and the interface of FIG. 28 is repeated. Upon adjusting the new identity tag and format tag information, the user may, again, invoke the assign filename button 2805.

The process flow in FIG. 29 begins when the assign filename button 2805 is selected. In it, the identity tag and format tag undergo a sequence of tests to ascertain their validity. These tests ensure correctly formed and unique identity tags and proper format tags.

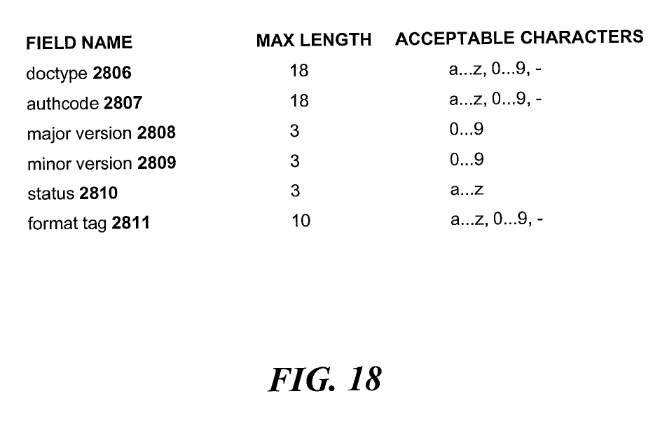

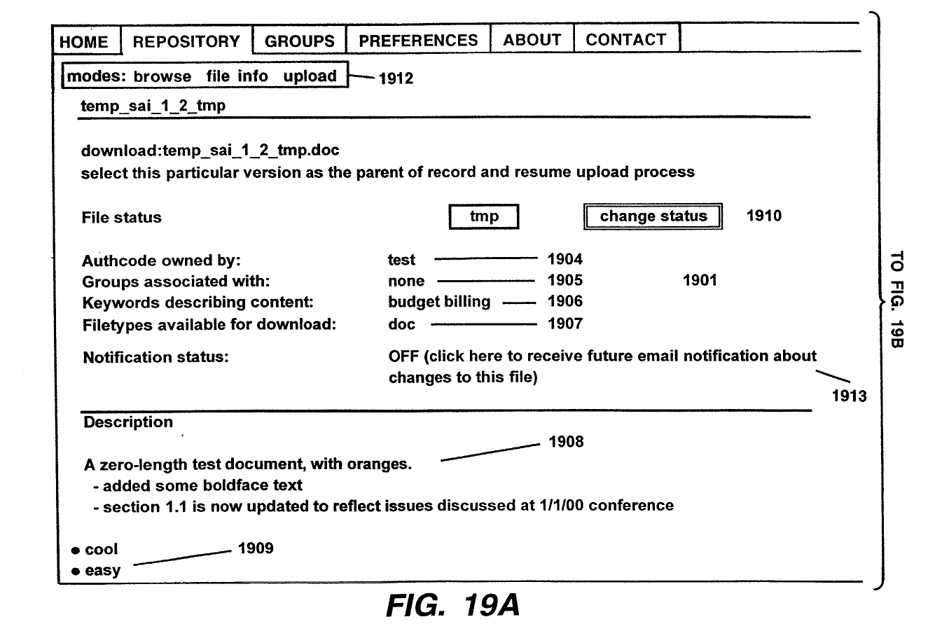

In step 2901, all fields in the interface form are tested for valid characters. Included in this test is a sub-test for blank fields, performed on the required fields: doctype 2806, authcode 2807, major version 2808, minor version 2809, status code 2810, and format tag 2811; the test is failed if any of the required fields is blank. Interface fields are tested to ensure they do not exceed a maximum length and that they contain only the allowable characters for the particular field. Valid lengths and characters sets are shown for each of the fields are illustrated in FIG. 18.

If any fields do not meet the criteria outlined in FIG. 18, the test 2901 fails, the user is informed of the invalid fields 2902, and the interface is redrawn. If all fields contain valid characters, the control passes to step 2903.

In step 2903, if the user has entered a new authcode 2803, the database is queried to ensure the authcode has no prior existence in the system 2904. If the authcode already exists, the user is informed that he may not use the authcode 2905, and the interface is redrawn. If no matches are found for the authcode in the database, the authcode is assigned to the user 2906, pending completion of this contribution process. If the user hasn't requested a new authcode in step 2903, control passes to step 2907.

In step 2907, if the user has entered a new format tag 2804, the database is queried to ensure the format tag has no prior existence in the system 2908. If the format tag exists in the database, inform the user that he does not need to create this format tag 2909, enter it in the format tag field 2811, clear the format tag request fields 2804, and redraw the interface. If no matches are found for the format tag in the database, the format tag is assigned to the user 2910, pending completion of this contribution process. If the user hasn't requested a new format tag in step 2907, control passes to step 2911.

In step 2911, the identity tag is tested to determine if it contains a new branch tag (comprised of doctype, authcode, and major version). If so, the identity tag has no history in the system; new document branches must begin at minor version zero (0) by convention. If this identity tag is a new branch, and it does not have a minor version of zero (0) 2912, the user is informed of the minor version requirement, the minor version is set to zero (0) 2913 and the interface is redrawn. If the identity tag is a new branch and it has a minor version of zero (0) 2912, the identity tag and format tags are valid, and this process is complete. If the identity tag is not a new branch, control proceeds to step 2914.

In step 2914, the identity tag is verified for uniqueness. If the identity tag already exists in the database, the document is assumed to be an update to documents in the specified branch. In this case, the user is informed that the identity tag exists, the minor version is incremented to the greatest minor version in the branch, plus one (1) 2915, and the interface is redrawn. If the identity tag is not found in the database, control passes to step 2916.

Step 2916 is an error trap for the case of the identity tag differing only in status code from another identity tag in the database. This case is an error because two identity tags having the same doctype, authcode, major version, and minor version represent the same document content, and the status code difference indicates a difference in acceptance of the content (e.g., accepted standard, temporary, development). A change status interface is provided and has been discussed previously. This interface allows a user to change the status code of a pre-existing document in the database. Through this interface, the document remains on the system, and change is noted in the identity tag only, ensuring that content remains identical. Users may not upload new files for status code changes on existing identity tags for the simple reason that the server computer system can not verify that the uploaded content matches the existing content. If the described status change error is detected 2916, the user is informed that the document must be assigned a new minor version number, the minor version is incremented to the greatest minor version in the branch, plus one (1) 2917, and the interface is redrawn. If no status code change error is detected, control passes to step 2918.

In step 2918, the minor version is tested to ensure that it is equal to the current greatest minor version number in the indicated branch, plus one (1). Failing 2919, the user is informed that the new identity tag must have the greatest minor version in the branch, the minor version is incremented to the greatest minor version in the branch, plus one (1) 2919, and the interface is redrawn. Otherwise, the identity tag and format tag have passed all tests and the tags are assigned to the document, pending completion of the contribution process.

FIG. 30 allows a user to select a parent of record for the uploaded document. The interface comprises two or more selections. At a minimum, the selections for parent of record are another file from the repository 3001 and no parent 3002. Additionally, selections for prior versions of the uploaded document in its indicated branch (not shown) can be displayed.

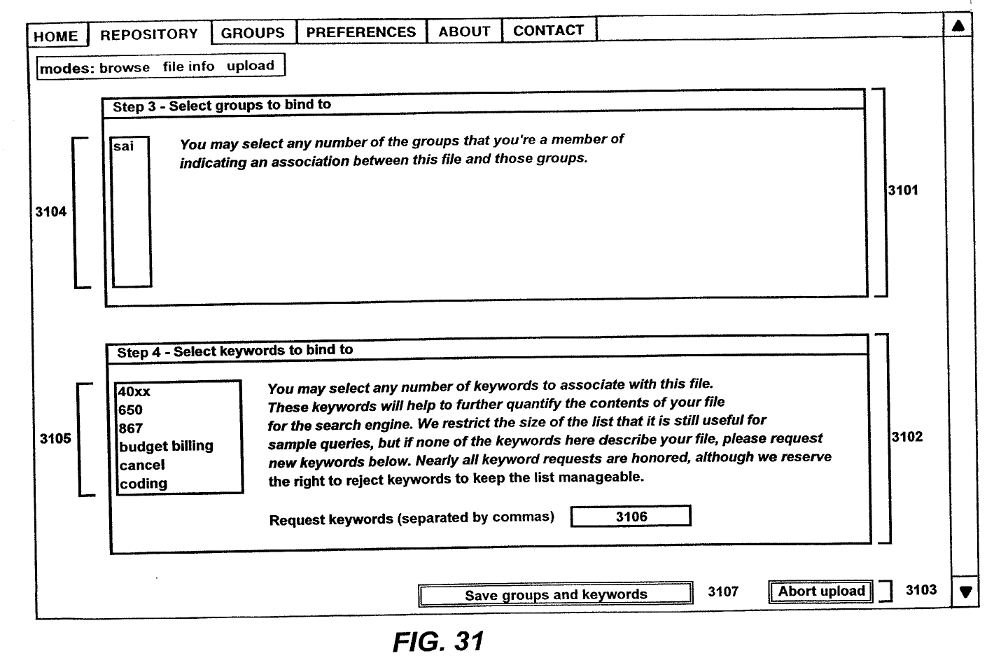

If the user specifies no parent of record 3002, no parent of record will be related to the document, and it will appear as the head of a new tree in the document ancestry tree. If the user specifies another document from the repository 3001 to act as parent of record, the contribution process is temporally suspended while the user chooses an arbitrary document. The list-context view of visible document objects is invoked, which the user may browse as described previously. In the detailed-context view for any document, a selection is added enabling the user to choose the current document as the parent of record for the contribution-in-progress document. Thus, to select an arbitrary parent of record, the user first locates an appropriate document in the list-context view, selects the document to obtain a detailed-context view, then selects the new choose-document-as-parent-of-record option present in the detailed-context interface. Control passes to the next interface, described in FIG. 31. Once a parent of record has been chosen, detailed-context document views will no longer show the choose-document-as-parent-of-record option.

If any additional selections for parent-of-record are shown in the interface of FIG. 30, they may be selected to set the parent-of-record to the named document. These selections occur if the document is an update to an existing branch; the selections are for prior versions of the document.

FIG. 31 is an interface that allows a user to select discussion groups and keywords to relate with the document object. The discussion groups selectable are those in which the user is currently a member. The keywords are those from the system-wide list. The interface of FIG. 31 is divided into three components, the assign discussion groups section 3101, the assign keywords section 3102 and the assign/abort buttons 3103. The discussion group selection interface 3101 has a scrolling list of discussion groups 3104 allowing selection of zero or more groups from the list. If the identity tag attached to the uploaded document is part of an existing branch, discussion groups related to prior documents in the branch are selected by default in the list.

The keyword selection interface 3102 has a scrolling keyword selection list 3105 allowing selection of zero or more keywords from the list, and a new keyword request interface 3106 that accepts a comma-separated list of keywords to insert into the system. New keywords requested will be entered into the database pending approval by the system administrator. If the identity tag attached to the uploaded document is part of an existing branch, keywords that are related to prior documents in the branch are selected by default in the list.

If the user invokes the save-groups-and-keywords button 3107, the add new keyword field 3106 is first checked for valid characters: alphanumeric characters and a dash (-) are permissible, keywords are separated by commas. If invalid characters are detected, the user is notified and the interface is redrawn. If the field contains valid characters, the specified groups 3104 and the specified keywords 3105 and 3106 are related to the document object in the database.

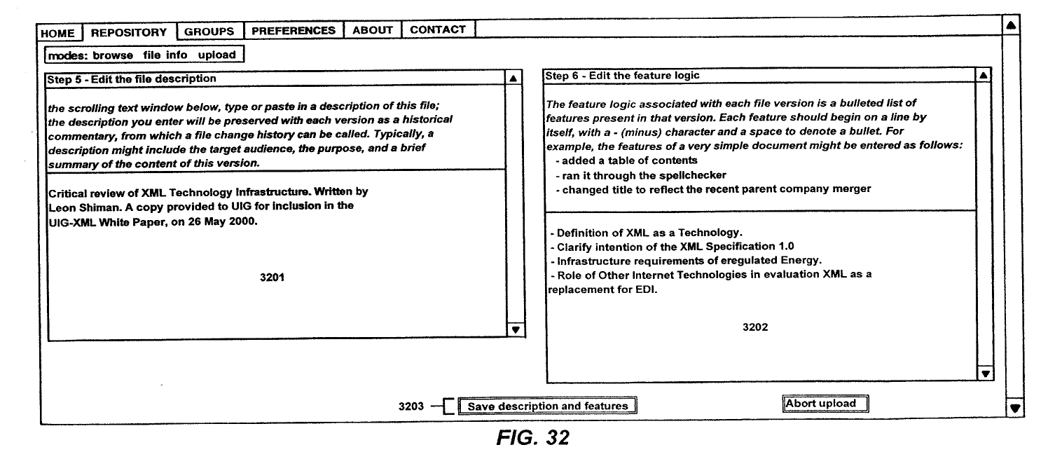

FIG. 32 is an interface that allows a user to edit a description and a feature list for the document. It contains three interface sections: a description editing interface 3201, a feature list editing interface 3202, and assign/abort buttons 3203. The description-editing interface 3201 is initialized by default with the description from the indicated parent-of-record. If no parent-of-record was selected, the description is blank. The interface allows a user to enter a description in plain text with his keyboard device or through a cut-and-paste style operation specific to particular web browser software.

The feature list-editing interface 3202 is initialized by default with the feature list from the indicated parent-of-record. If no parent-of-record was selected, the feature list is blank. The interface allows a user to enter a feature list in plain text with his keyboard device or through a cut-and-paste style operation specific to particular web browser software.

Once the user invokes the save-description-and-features button 3203, the specified description and feature list are stored in the document object. No validity checking is performed because no tests are applicable to this type of information.

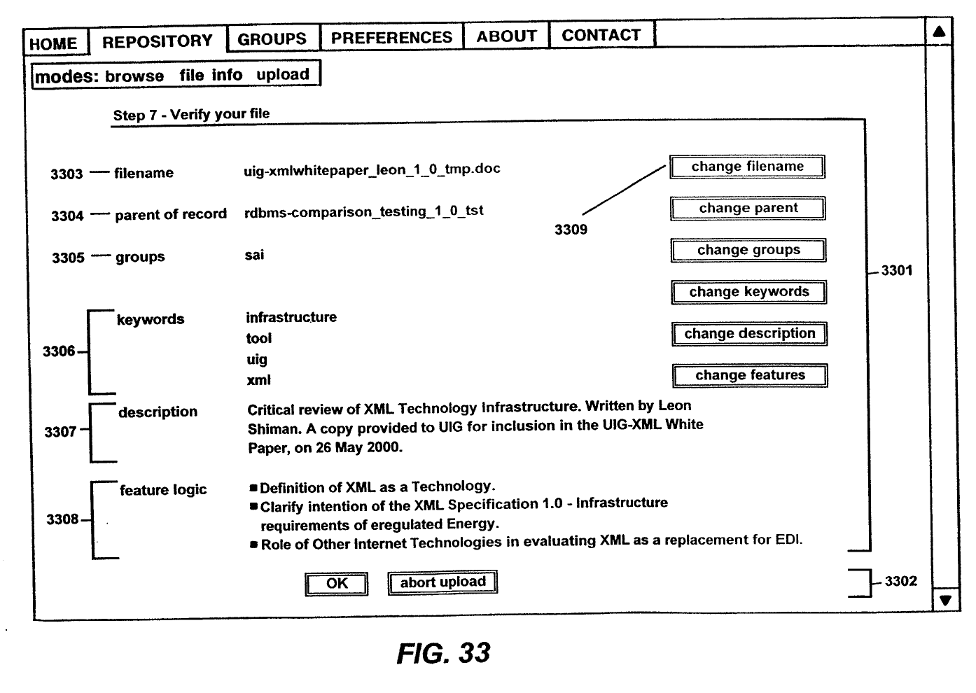

FIG. 33 is an interface that allows a user to view, in summary, the information generated about the document during the contribution process, and it allows the user to return to prior interfaces to alter information. The interface is divided into two sections, an information display and change function section 3301 and confirm/abort buttons 3302. The informative display 3301 lists the values of attributes assigned to the document during the contribution process. A change button 3309 accompanies each attribute, allowing the user to return to the interface applicable to the attribute. This section comprises six attributes: file name (identity tag and format tag) 3303, parent-of-record 3304, discussion groups 3305, keywords 3306, description 3307, and feature list 3308. One should note that the groups 3305 and keywords 3306 assignment interfaces are on the same screen, shown in FIG. 31; this is also true for the description 3307 and feature list 3308 interfaces, shown in FIG. 32. As indicated in the process flow diagram of FIG. 29, each change operation invokes the necessary interface, then returns to the described confirmation interface in FIG. 33.

The user indicates his acceptance of the document information by selecting the “OK” button 3302. The document object is created by the server system, storing the following list of eight attribute values and relations: the new document's identity tag (including doctype, authcode, major, minor and status codes0, the file format tag for the new document, the identity tag of the parent of record, groups to relate to this branch tag, keywords to relate to this branch tag, a description of this document, the feature list of this document and a modification time for the document.

Users may attach their names to a change notification list for a branch tag in the document database. Users on the list will be notified through electronic mail when an update has occurred to a document in the chosen branch. Changes include, but are not limited to, new minor versions, status code changes, and new formats made available. The notification mechanism is shown in the detailed-context document view of FIG. 19, as a toggle selection 1913. It is not present on the interface screen when the document object is viewed by its owner because the document owner is the only user allowed to change the document and he would already be aware of any changes. For non-owners, the notification mechanism 1913 is a toggle switch allowing users to change their notification status for the particular document.

If the user is currently not on the notification list of a document's branch, when the user invokes the notification toggle function 1913, his user name is inserted into the notification list. If the user is already on the list, invoking the notification toggle function 1913 deletes his user name from the list. Every update, insert, or deletion from the database also includes execution of the notification functionality. The nature of the update, insert, or deletion, and the document that it affects are used to generate a mass e-mailing to users on its notification list.

When a database object is related to one or more discussion groups, the server will refuse to serve that object to a user who is not also related to (i.e., a member of) at least one of those discussion groups. In the preferred embodiment, this security function is invoked during execution of the process described in FIG. 6 for standard requests over the World Wide Web. Specifically, in step 606, the following three conditions are applicable:

First, if the object to be served is a detailed-context discussion group view: the user will be unable to read the contents of groups of which he is not a member. No e-mail traffic from the groups will be directed at the non-member, and no e-mail traffic from the non-member will be posted to the discussion group. Second, if the object to be served is a detailed context user object view: the user will not be served information of other system users who are not members of the discussion groups in which this user is a member. Finally, if the object to be served is a detailed context document view: the user will not be served documents that aren't related to the discussion groups of which the user is a member.

Additionally, objects denied under the above three criteria will not be shown in a list-context view. No mention of the denied object will be made in the list. For instance, a denied document will not be shown in a list of documents; the list generator will simply skip over it.

In one embodiment, a function of the server system generates web pages that provide read-only access to limited document objects. Each web page is an index to document objects related to a single discussion group. The static web page generator queries the database for documents that meet specified criteria (e.g. matching a named keyword, related to a specified discussion group, etc.). It produces a single, static web page that allows a user to retrieve the documents from the server but does not allow them access to upload information. Users of the static pages may not contribute new information to the repository nor will they have access to the document ancestry tree and relations with other system objects. Readers of these static pages need not have an account with the server system of the present invention.

The web page can be located on a physically separate remote computer system, thereby isolating the public read-only system from the full access system. In general, such pages contain a processed version of the identity tag so as not to confuse the user, the modification time, the owner, the description and the features for that particular identity tag, and hyperlinks that allow the user to download the document in one of the supplied file formats.

A software implementation of the above-described embodiment may comprise a series of computer instructions either fixed on a tangible medium, such as a computer readable media, e.g. diskette, CD-ROM, ROM, or fixed disk, or transmittable to a computer system, via a modem or other interface device, such as a communications adapter connected to the network over a medium. The medium either can be a tangible medium, including but not limited to optical or analog communications lines, or may be implemented with wireless techniques, including but not limited to microwave, infrared or other transmission techniques. It may also be the Internet.

The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, pre-loaded with a computer system, e.g., on system ROM or fixed disk, or distributed from a server or electronic bulletin board over a network, e.g., the Internet or World Wide Web.

Although an exemplary embodiment of the invention has been disclosed, it will be apparent to those skilled in the art that various changes and modifications can be made which will achieve some of the advantages of the invention without departing from the spirit and scope of the invention. For example, it will be obvious to those reasonably skilled in the art that such specific details need not be used to practice the present invention. Further, some well-known structures, interfaces, and processes have not been shown in detail in order to avoid unnecessarily obscuring the present invention. In addition, although the following description is concerned with the storage and retrieval of documents in particular, the present invention is not limited to documents and applies to a variety of media such as images, audio, and software programs.

What is claimed is:

1. A method for managing documents in a centralized document repository having a server on which document copies are stored and requested by a plurality of users, the method comprising:
(a) requiring each of the users to obtain all copies of the documents from the server;
(b) when an original document is entered into the server by a document owner, assigning a name to the original document where the name is independent of the content and location of the original document and has a fixed format;
(c) including an authcode identifying the document owner in the original document name at a first predetermined location in the fixed format; and
(d) including a version number indicating changes to the original document in the original document name at a second predetermined location in the fixed format.

2. The method of claim 1 further comprising:
(e) including in the original document name at a third predetermined location in the fixed format, a short description assigned by the document owner.

3. The method of claim 2 further comprising:
(f) including in the original document name at a fourth predetermined location in the fixed format, a code indicating the format of the original document.

4. The method of claim 3 further comprising:
(g) when a user requests a copy of an original document in the server assigning a new name to the document copy wherein the authcode, document type and format code in the new name remains the same as the authcode, document type and format code in the original document name and the version number is changed.

5. The method of claim 1 further comprising requiring each user to log onto the server with a logon name and wherein step (c) comprises generating a user authcode from the user logon name.

6. The method of claim 1 wherein step (d) comprises using the server to generate and assign the version number.

7. The method of claim 1 further comprising:
(h) requiring each of the users to store all copies of an original document obtained from the server back on the server.

8. The method of claim 1 wherein content of the original document includes text, images, audio data, software programs and e-mail messages.

9. The method of claim 1 wherein step (b) comprises receiving metadata information from the document owner and storing the metadata information with the original document.

10. The method of claim 9 wherein the metadata includes group membership information.

11. The method of claim 10 further comprising limiting access to the original document based on the group membership information.

12. The method of clam 10 further comprising searching in the document repository using the metadata information.

13. Apparatus for managing documents in a centralized document repository having a server on which document copies are stored and requested by a plurality of users, the apparatus comprising:
a login mechanism that requires each of the users to obtain all copies of the documents from the server;
a name generator in the server that is responsive to an original document being entered into the server by a document owner for assigning a name to the original document;
wherein the name is independent of the content and location of the original document, has a fixed format, includes an authcode identifying the document owner in the original document name at a first predetermined location in the fixed format; and a version number indicating changes to the original document in the original document name at a second predetermined location in the fixed format.

14. The apparatus of claim 13 wherein the original document name comprises a short description assigned by the document owner located at a third predetermined location in the fixed format,.

15. The apparatus of claim 14 wherein the original document name comprises a code indicating the format of the original document located at a fourth predetermined location in the fixed format.

16. The apparatus of claim 15 wherein the name generator further comprises a name modifier that operates when a user requests a copy of an original document in the server to assign a new name to the document copy wherein the authcode, document type and format code in the new name remains the same as the authcode, document type and format code in the original document name and the version number is changed.

17. The apparatus of claim 13 further comprising a login mechanism that requires each user to log onto the server with a logon name and a authentication mechanism that generates a user authcode from the user logon name.

18. The apparatus of claim 13 wherein the server comprises a version tracker that generates and assigns the version number.

19. The apparatus of claim 13 further comprising a mechanism that requires each of the users to store all copies of an original document obtained from the server back on the server.

20. The apparatus of claim 13 wherein content of the original document includes text, images, audio data, software programs and e-mail messages.

21. The apparatus of claim 13 further comprising an interface mechanism that receives metadata information from the document owner and stores the metadata information with the original document.

22. The apparatus of claim 21 wherein the metadata includes group membership information.

23. The apparatus of claim 22 further comprising a restriction mechanism that limits access to the original document based on the group membership information.

24. The apparatus of clam 22 further comprising a search mechanism that searches in the document repository using the metadata information.

25. A computer program product for managing documents in a centralized document repository having a server on which document copies are stored and requested by a plurality of users, the computer program product comprising a computer usable medium having computer readable program code thereon, including:
program code for requiring each of the users to obtain all copies of the documents from the server;
program code operable when an original document is entered into the server by a document owner, for assigning a name to the original document where the name is independent of the content and location of the original document and has a fixed format;
program code that includes an authcode identifying the document owner in the original document name at a first predetermined location in the fixed format; and
program code that includes a version number indicating changes to the original document in the original document name at a second predetermined location in the fixed format.

26. The computer program product of claim 25 further comprising:
program code that includes in the original document name at a third predetermined location in the fixed format, a short description assigned by the document owner.

27. The computer program product of claim 26 further comprising:
program code for including in the original document name at a fourth predetermined location in the fixed format, a code indicating the format of the original document.

28. The computer program product of claim 27 further comprising:
program code operable when a user requests a copy of an original document in the server for assigning a new name to the document copy wherein the authcode, document type and format code in the new name remains the same as the authcode, document type and format code in the original document name and the version number is changed.

29. A computer data signal embodied in a carrier wave for managing documents in a centralized document repository having a server on which document copies are stored and requested by a plurality of users, the computer data signal comprising:
program code for requiring each of the users to obtain all copies of the documents from the server;
program code operable when an original document is entered into the server by a document owner, for assigning a name to the original document where the name is independent of the content and location of the original document and has a fixed format;
program code that includes an authcode identifying the document owner in the original document name at a first predetermined location in the fixed format; and
program code that includes a version number indicating changes to the original document in the original document name at a second predetermined location in the fixed format.
